(19) United States
(12) Patent Application Publication
(10) Pub. No.: US 2023/0229990 A1
(43) Pub. Date: Jul. 20, 2023

(54) PUNCH ITEM BUILDER INTERFACE

(71) Applicant: MiView Integrated Solutions, LLC, Carrollton, TX (US)

(72) Inventor: Luis A. Uriarte, Frisco, TX (US)

(73) Assignee: MiView Integrated Solutions, LLC, Carrollton, TX (US)

(21) Appl. No.: 18/123,952

(22) Filed: Mar. 20, 2023

Related U.S. Application Data
(63) Continuation-in-part of application No. 17/944,913, filed on Sep. 14, 2022.
Application No. 17/944,913 is a continuation of application No. 17/351,982, filed on Jun. 18, 2021, now Pat. No. 11,481,702.
(60) Provisional application No. 63/040,908, filed on Jun. 18, 2020.
(60) Provisional application No. 63/208,739, filed on Jun. 9, 2021.

(51) Int. Cl. G06Q 10/0631; G06Q 50/08; G06Q 10/0875; G06Q 10/10

(52) U.S. Cl. CPC G06Q 10/063114; G06Q 50/08; G06Q 10/063116; G06Q 10/063118; G06Q 10/0875; G06Q 10/103

(57) ABSTRACT

A method implements a punch item builder interface. The method includes receiving a punch image from a builder interface. The punch image depicts a worksite corresponding to a task of a checklist item presented in a checklist view. The method further includes updating the checklist item with a punch thumbnail corresponding to the punch image. The method further includes presenting the checklist view with a notification and with the checklist item updated to include a punch review thumbnail of a punch review image from a trade interface. The method further includes presenting the punch review image from the trade interface responsive to the punch review thumbnail. The method further includes updating the checklist item with a punch review thumbnail corresponding to the punch review image.

### CROSS REFERENCE TO RELATED APPLICATIONS

This application is a continuation in part of U.S. application Ser. No. 17/944,913, filed Sep. 14, 2022; U.S. application Ser. No. 17/944,913 is a continuation of U.S. application Ser. No. 17/351,982, filed Jun. 18, 2021; U.S. application Ser. No. 17/351,982 claims the benefit of U.S. Provisional Application 63/040,908, filed Jun. 18, 2020, and U.S. Provisional Application 63/208,739, filed Jun. 9, 2021. Each of the applications identified above are incorporated by reference herein. This application is related to US application NUMBER [Attorney docket number 10534/029001], filed on DATE, and to US application NUMBER [Attorney docket number 10534/0028001], filed on DATE, which are each incorporated by reference herein.

### BACKGROUND

Worksite information management systems track and process information about worksites. Worksite information management systems create, schedule, and track tasks and milestones. A challenge with worksite information management systems is to provide builder interfaces that communicate relevant information to multiple types of users, including workers, supervisors, builders, inspectors, etc.

### SUMMARY

In general, in one or more aspects, the disclosure relates to a method that implements a punch item builder interface. The method includes receiving a punch image from a builder interface. The punch image depicts a worksite corresponding to a task of a checklist item presented in a checklist view. The method further includes updating the checklist item with a punch thumbnail corresponding to the punch image. The method further includes presenting the checklist view with a notification and with the checklist item updated to include a punch review thumbnail of a punch review image from a trade interface. The method further includes presenting the punch review image from the trade interface responsive to the punch review thumbnail. The method further includes updating the checklist item with a punch review thumbnail corresponding to the punch review image.

In general, in one or more aspects, the disclosure relates to a system. The system includes at least one processor. The system further includes an image controller configured to generate a punch thumbnail from a punch image. The system further includes an application executing on the at least one processor. The application is configured for receiving the punch image from a builder interface. The punch image depicts a worksite corresponding to a task of a checklist item presented in a checklist view. The application is further configured for updating the checklist item with the punch thumbnail corresponding to the punch image. The application is configured for presenting the checklist view with a notification and with the checklist item updated to include a punch review thumbnail of a punch review image from a trade interface. The application is configured for presenting the punch review image from the trade interface responsive to the punch review thumbnail. The application is configured for updating the checklist item with a punch review thumbnail corresponding to the punch review image.

In general, in one or more aspects, the disclosure relates to a computer program product that includes a non-transitory computer-readable program code that, when executed by a computer processor of a computing system, causes the computing system to perform operations. The non-transitory computer-readable program code is configured for receiving a punch image from a builder interface. The punch image depicts a worksite corresponding to a task of a checklist item presented in a checklist view. The non-transitory computer-readable program code is further configured for updating the checklist item with a punch thumbnail corresponding to the punch image. The non-transitory computer-readable program code is further configured for presenting the checklist view with a notification and with the checklist item updated to include a punch review thumbnail of a punch review image from a trade interface. The non-transitory computer-readable program code is further configured for presenting the punch review image from the trade interface responsive to the punch review thumbnail. The non-transitory computer-readable program code is further configured for updating the checklist item with a punch review thumbnail corresponding to the punch review image.

Other aspects of the invention will be apparent from the following description and the appended claims.

### BRIEF DESCRIPTION OF DRAWINGS

FIG. 1A, FIG. 1B, and FIG. 2 show diagrams of systems in accordance with disclosed embodiments.

FIG. 3 shows a flowchart in accordance with disclosed embodiments.

FIG. 4, FIG. 5A, FIG. 5B, FIG. 5C, FIG. 5D, FIG. 6A, FIG. 6B,

FIG. 6C, FIG. 7A, FIG. 7B, FIG. 7C, FIG. 7D, FIG. 7E, FIG. 7F, FIG. 7G, FIG. 8A, FIG. 8B, FIG. 8C, FIG. 8D, FIG. 8E, FIG. 8F, FIG. 8G, FIG. 8H, FIG. 9A, FIG. 9B, FIG. 9C, FIG. 9D, FIG. 9E, FIG. 10A, FIG. 10B, FIG. 10C, FIG. 10D, FIG. 11A, FIG. 11B, FIG. 11C, and FIG. 11D shows examples in accordance with disclosed embodiments.

FIG. 12A and FIG. 12B show computing systems in accordance with disclosed embodiments.

### DETAILED DESCRIPTION

In general, embodiments of the disclosure automate scheduling and generate records for remote tracking, reviews, and inspections using a worksite information management system. The worksite information management system provides a suite of software products that integrate multiple independent entities of an industry providing live visibility, accountability, and automated scheduling. These features are available to each of the entities using the system giving the entities flexibility to work in the field or virtually without the need for physical interaction. The worksite information management system performs real-time reporting of industry specific metrics for each of the entities with the ability to see daily schedule variances of planned versus actual. Integrated alerts and messaging allow seamless connectivity to all entities for the users of the system. Optimized scheduling allows for just in time (JIT) material delivery resulting in increased ability to manage the scheduling and execution of jobs, reviews, and inspections at a worksite.

A job is a set of tasks that are performed at a worksite. A job may be part of a job bundle, which is a set of jobs that are performed at a worksite.

A worksite is a location where jobs are performed. For example, with the new home construction industry, a worksite is the location of the property on which the home is to be constructed.

Job information includes the data and records stored by the system for jobs performed at a worksite and may be stored using numeric and alphanumeric formats. Job information includes job identifiers, job type identifiers and descriptions, start dates, completion dates, job bundle identifiers, job status identifiers and descriptions, crew assignment identifiers, reviewer assignment identifiers, inspector identifiers, job dependency identifiers, job history descriptions, job triggers, job trigger actions, walk review result data, inspection result data, job results data, etc.

A trigger in the system is a record that identifies an action to take after an update is received. For example, receiving the home specification data and customizations may trigger the system to automatically generate schedule data with start dates and projected completion dates for the jobs, reviews, and inspections of a construction project.

Schedule information includes the data and records used by the system to identify the timing of events at a worksite and may be stored using numeric and alphanumeric formats. Schedule information includes job identifiers, schedule templates, job start dates, projected completion dates, job completion dates, crew assignment identifiers, reviewer identifiers, inspection identifiers, etc.

A schedule template is a record that may identify a set of tasks, the durations for the tasks, and the dependencies between the tasks. A builder may have several base model homes and each base model home may have a schedule template that identifies the tasks needed to construct the home along with the durations and dependencies of the tasks. After the specification of a home has been customized and approved, the schedule template may be updated to reflect the customizations.

A timestamp identifies a point in time using a number or string of characters. A timestamp may identify hours, minutes, seconds, milliseconds, month, day of month, day of week, week of year, year, etc., of a point in time and may be relative to another point in time.

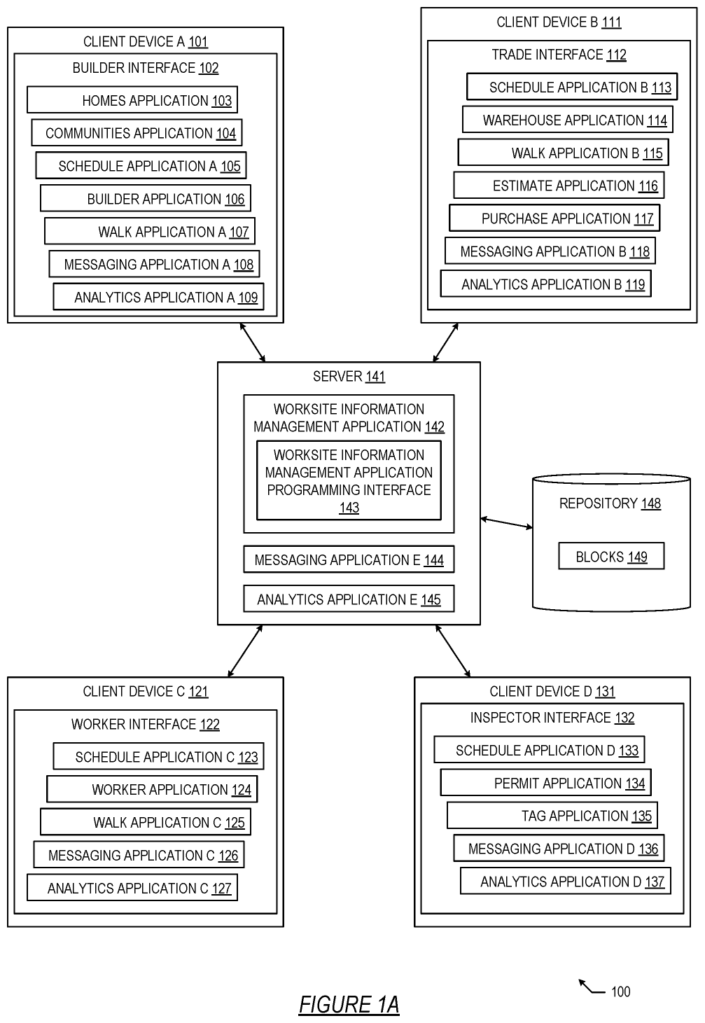

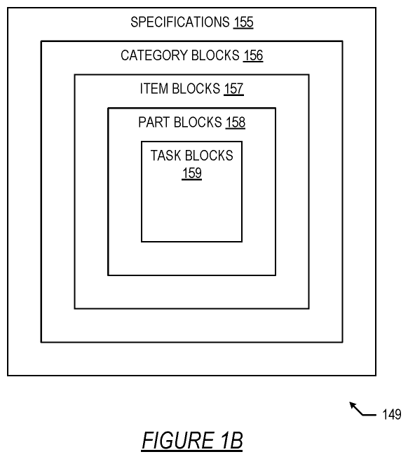

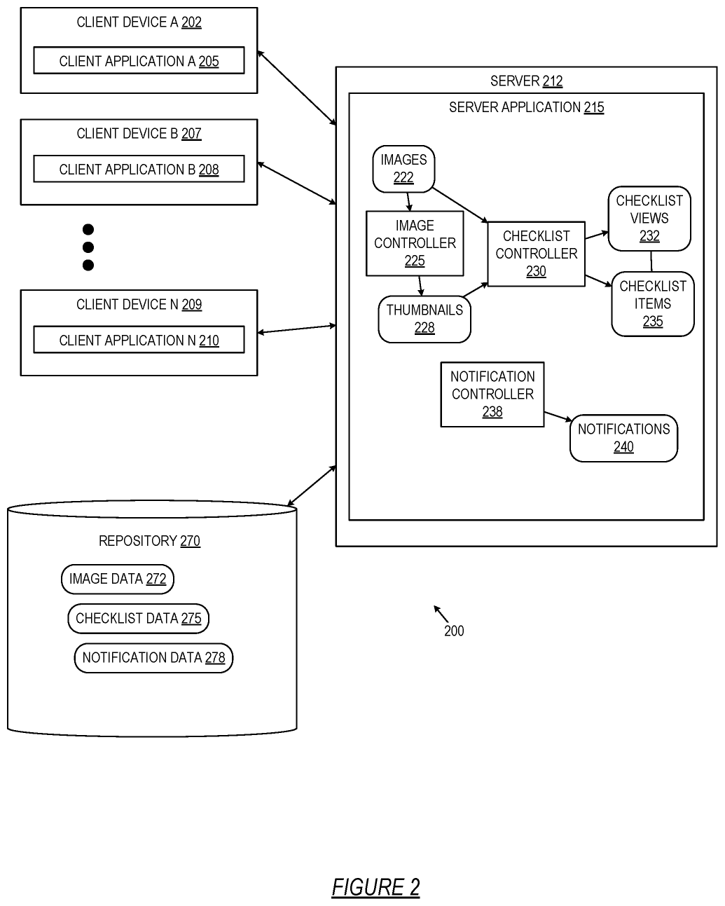

FIGS. 1A, 1B, and 2 show diagrams of embodiments that are in accordance with the disclosure. FIG. 1A shows the system (100) that implements a worksite information management system. FIG. 1B shows the blocks (149) that record data communicated throughout the system (100). FIG. 2 shows a diagram of a worksite information management system. The embodiments of FIGS. 1A, 1B, and 2 may be combined and may include or be included within the features and embodiments described in the other figures of the application. The features and elements of FIGS. 1A, 1B, and 2 are, individually and as a combination, improvements to worksite information management technology and computing systems. The various elements, systems, and components shown in FIGS. 1A, 1B, and 2 may be omitted, repeated, combined, and/or altered as shown from FIGS. 1A, 1B, and 2. Accordingly, the scope of the present disclosure should not be considered limited to the specific arrangements shown in FIGS. 1A, 1B, and 2.

Turning to FIG. 1A, the system (100) manages worksite information. The server (141) processes and communicates worksite information to the client devices A (101), B (111), C (121), and D (131) using the blocks (149) stored in the repository (148).

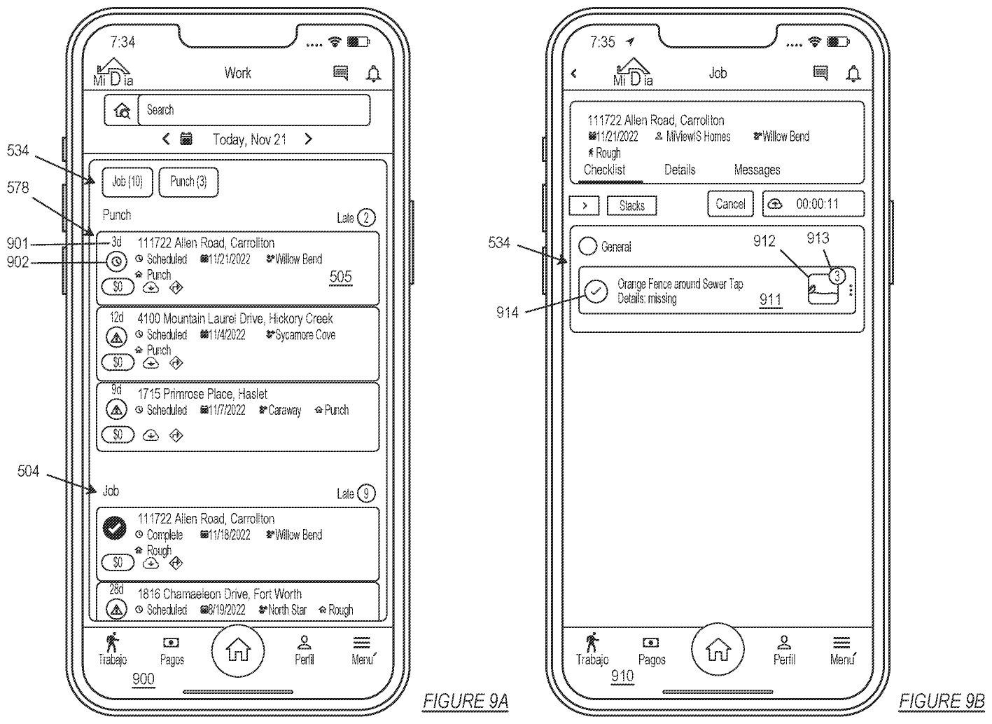

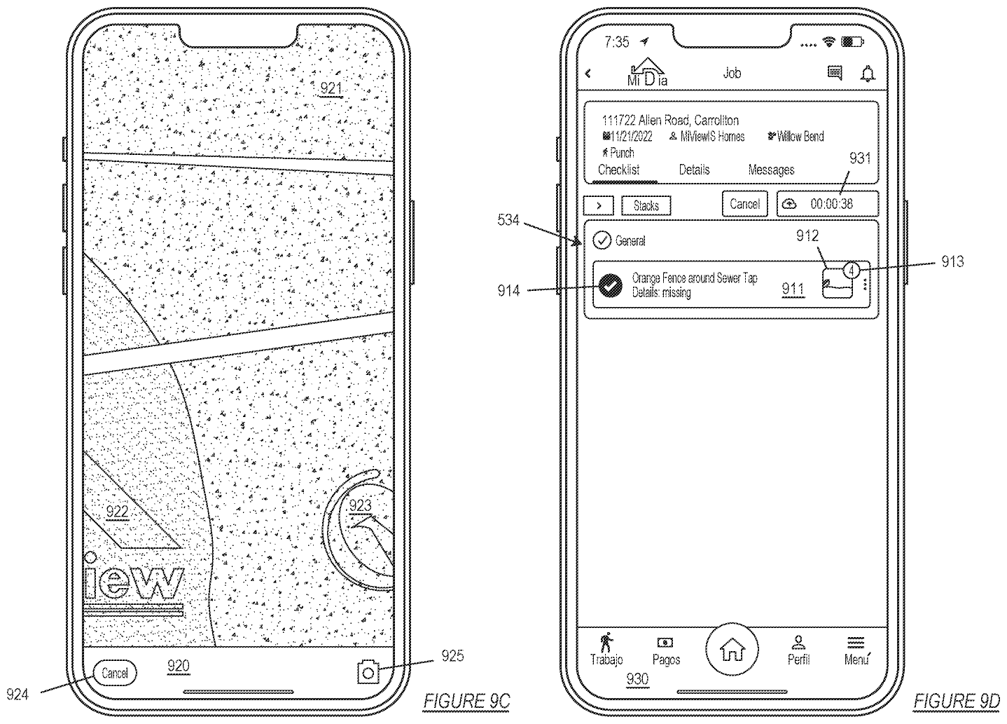

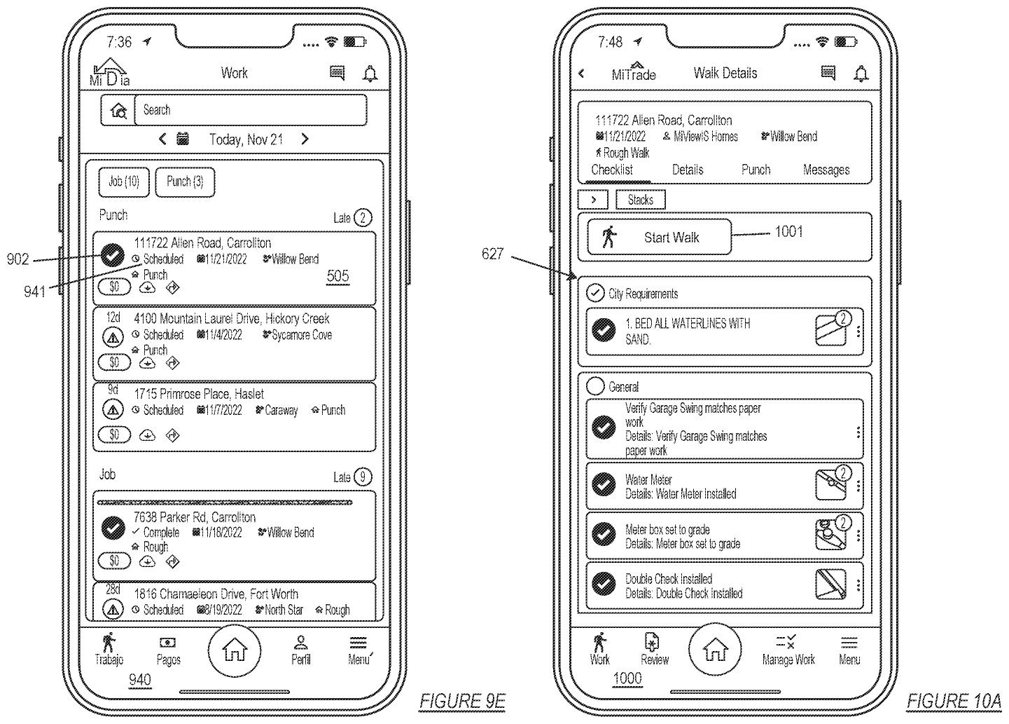

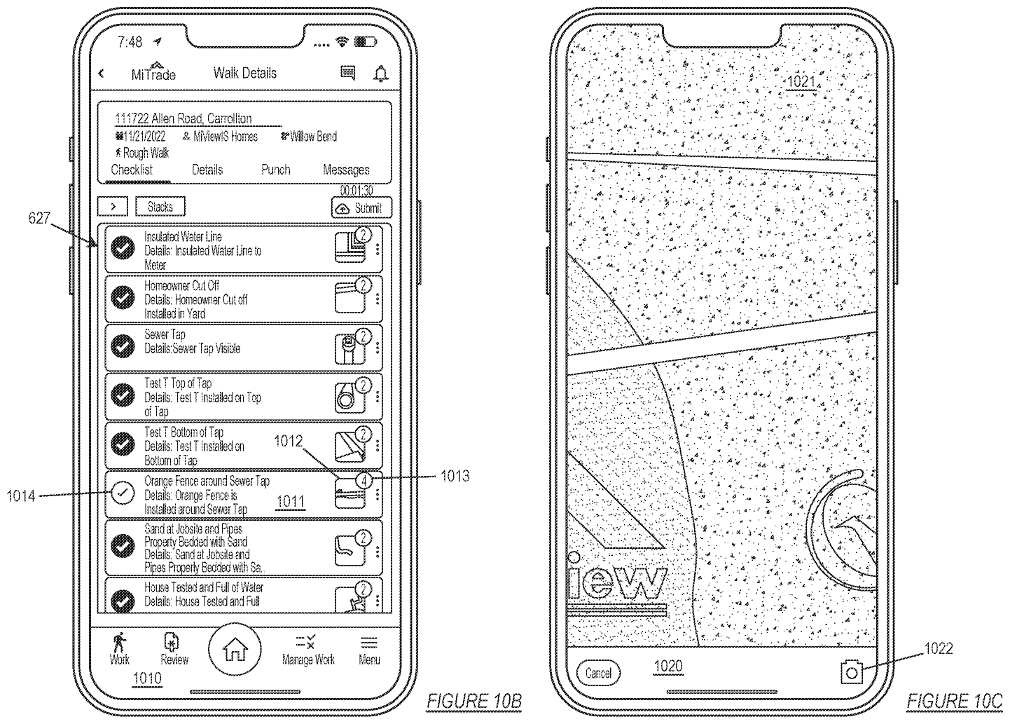

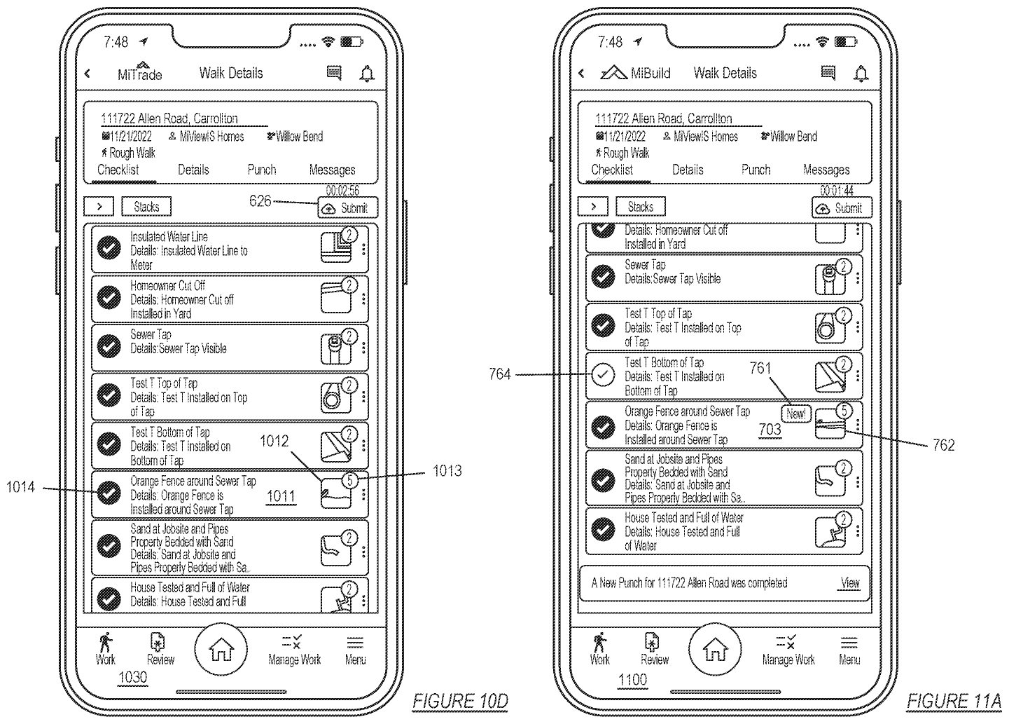

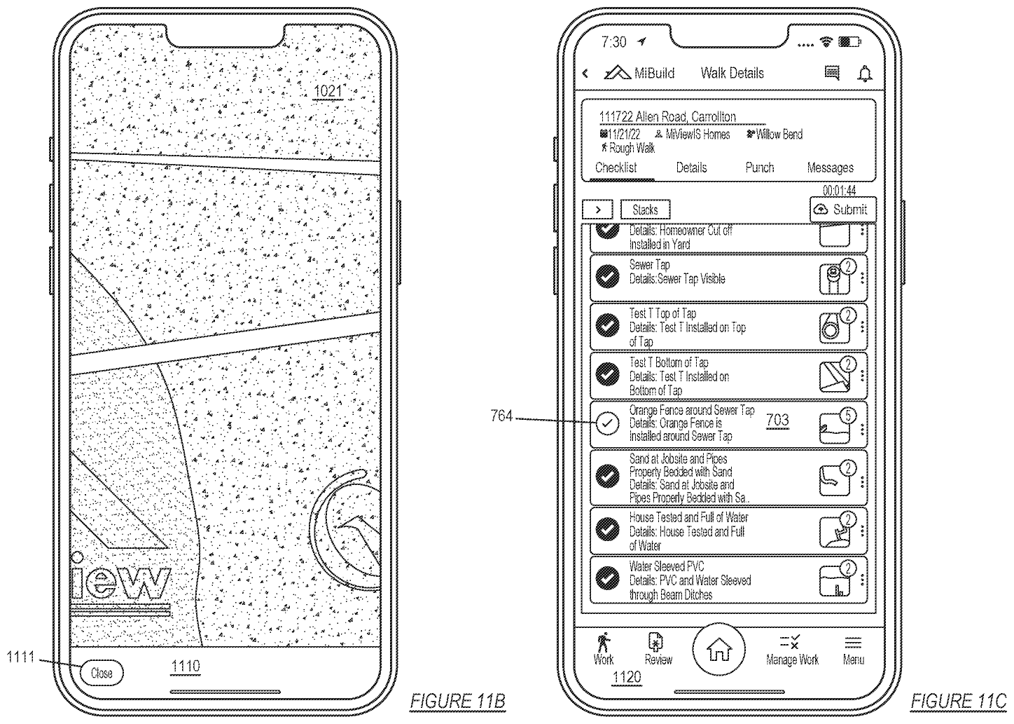

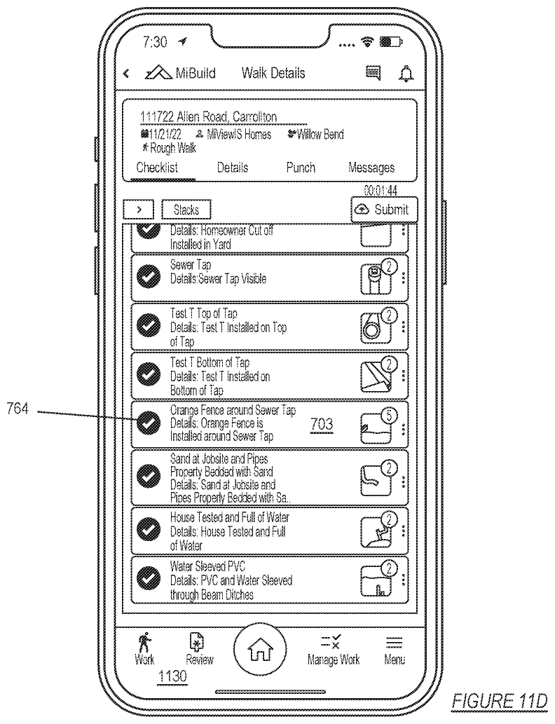

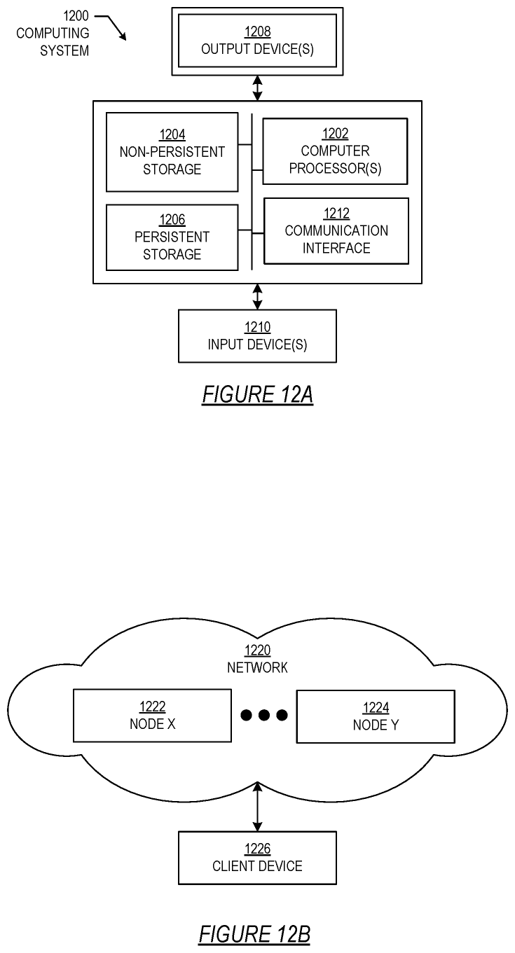

The client devices A (101), B (111), C (121), and D (131) are computing systems (further described in FIG. 12A). For example, the client devices A (101), B (111), C (121), and D (131) may be desktop computers, mobile devices, laptop computers, tablet computers, etc.

The server (141) is a computing system (further described in FIG. 12A). The server (141) may include multiple physical and virtual computing systems that form part of a cloud computing environment. In one embodiment, execution of the programs and applications of server (141) is distributed to multiple physical and virtual computing systems in the cloud computing environment.

The interfaces (102), (112), (122), and (132) are interfaces to the applications running on the system (100). The interfaces (102), (112), (122), and (132) may be part of a native application or may be a browser application that sends and receives messages to and from the worksite information management application (142).

The builder interface (102) executes on the client device A (101) and is used by a builder to access the system to view and manipulate schedules, notifications, messages, etc. For example, a user of a builder may use the builder interface (102) to plan communities and schedule contractors to build houses.

The trade interface (112) executes on the client device B (111) and is used by a supervisor to access the system to view and manipulate schedules, notifications, messages, etc. For example, a supervisor of a contractor may use the trade interface (112) to access a machine learning model to schedule workers for a worksite.

The worker interface (122) executes on the client device C (121) and is used by a worker to access the system to view and manipulate schedules, notifications, messages, etc. For example, a worker may be at a worksite and use the worker interface (122) to identify that a task block is complete with evidence (e.g., a picture with geolocation coordinates).

The inspector interface (132) executes on the client device D (131) and is used by an inspector (e.g., a city inspector, a county inspector, etc.) to access the system to view and manipulate schedules, notifications, messages, etc. For example, an inspector may use the inspector interface (132) to review the evidence of the work performed at a worksite.

The interfaces (102), (112), (122), and (132) interactively display information from multiple applications running on the client devices A (101), B (111), C (121), and D (131) and the server (141). The applications running on the client devices A (101), B (111), C (121), and D (131) communicate with the worksite information management application (142) through the worksite information management application programming interface (143).

The homes application (103) operates on the client device A (101). The homes application (103) is used by a builder to generate, process, and view the blocks used for the homes of a community. In one embodiment, the homes application (103) may operate on a client device of the home buyer and be used to access the data about the home (e.g., scheduling, part selections, etc.).

The communities application (104) operates on the client device A (101). The communities application (104) is used by a builder to plan and view the homes of communities of a builder.

The schedule applications A (105), B (113), C (123), and D (133) operate on the client devices A (101), B (111), C (121), and D (131). The schedule applications A (105), B (113), C (123), and D (133) show the schedules for the task blocks for the homes being built.

The builder application (106) operates on the client device A (101). The builder application (106) is used by the users of the builder to access the other applications through the builder interface (102).

The walk applications A (107), B (115), and C (125) operate on the client devices A (101), B (111), and C (121). The walk applications A (107), B (115), and C (125) display information used while a user is walking on the worksite to capture evidence (e.g., images) while at the worksite. The walk applications A (107), B (115), and C (125) may also be used to view the evidence away from the worksite.

The messaging applications A (108), B (118), C (126), and D (136) operate on the client devices A (101), B (111), C (121), and D (131) in conjunction with the messaging application E (144) operating on the server (141). The messaging applications A (108), B (118), C (126), D (136), and E (144) pass messages back and forth though the system to communicate and process data and information about the blocks (149). The other applications of the system (100) use the messaging applications A (108), B (118), C (126), D (136), and E (144) to transfer information in the system (100).

The analytics applications A (109), B (119), C (127), and D (137) operate on the client devices A (101), B (111), C (121), and D (131) in conjunction with the analytics application E (145) operating on the server (141). The analytics applications A (109), B (119), C (127), D (137), and E (145) display, communicate, and process analytics data through the system (100). The analytics data includes how often tasks, individuals, or companies are not completed on time, how often tasks, individuals, or companies do not pass inspection, etc. The analytics applications A (109), B (119), C (127), D (137), and E (145) may also use machine learning models to make predictions. For example, the analytics application E (145) may train a machine learning model to predict which worker will be selected for a task block.

The warehouse application (114) operates on the client device B (111). The warehouse application (114) is used by a supervisor to monitor and schedule shipments from warehouses to worksites.

The estimate application (116) operates on the client device B (111). The estimate application (116) is used by a contractor to provide estimates to builders (e.g., through the builder application (106)) for task blocks that may be performed by the contractor.

The purchase application (117) operates on the client device B (111). The purchase application (117) is used by a contractor to purchase supplies for a worksite.

The worker application (124) operates on the client device C (121). The worker application (124) is used by a worker to communicate with the contractor. For example, the worker application (124) may be used to communicate why work may not be completed on time or to request additional information about a task block.

The permit application (134) operates on the client device D (131). The permit application (134) is used by an inspector to issue permits for tasks for a worksite. In one embodiment, the permit application (134) may also operate on the client device A (101) and be used by a user of a builder to request a permit.

The tag application (135) operates on the client device D (131). The tag application (135) is used by an inspector to report and document building code violations for a worksite. For example, red tags may be for a set of building code violations that need to be remediated before construction can continue and green tags may be for certification that a stage meets building code.

The worksite information management application (142) is a collection of programs operating on the server (141) using the worksite information management application programming interface (143). The worksite information management application (142) may be implemented as a web application or service that communicates with the other applications over a network.

In one embodiment, the worksite information management application (142) includes a web store of digital assets that hosts an online catalog where builders (using the builder interface (102)), municipalities (using the inspector interface (132)), and vendors (using the trade interface (112)) can browse sets of pre-populated construction blocks (e.g., the blocks (149)). The digital assets include designs and materials that can be imported into the plans and specifications maintained by the system (100). By using sets of established blocks traded through the web store, the system (100) ensures uniformity across the platform for the different devices and companies. Third parties may create and submit block packages to the marketplace where the block packages can be acquired by other users of the system (100).

The repository (148) is a computing system that may include multiple computing devices in accordance with the computing system (1200) and the nodes (1222) and (1224) described below in FIGS. 12A and 12B. The repository (148) may be hosted by a cloud services provider that also hosts the server (141). The cloud services provider may provide hosting, virtualization, and data storage services as well as other cloud services and to operate and control the data, programs, and applications that store and retrieve data from the repository (148). The data in the repository (148) includes the blocks (149), which are further described below with FIG. 1B.

Turning to FIG. 1B, the blocks (149) store the information used by the system (100) (of FIG. 1A). The blocks (149) stored in the repository (148) (of FIG. 1A) include a hierarchy. The blocks (149) include the specifications (155), the category blocks (156), the item blocks (157), the part blocks (158) and the task blocks (159). The blocks (149) may be stored as electronic files on the repository (148) (of FIG. 1A).

The specifications (155) are digital representation of a list of tasks and items. A specification summarizes the building guidelines of a particular plan for a home. A specification is composed of multiple blocks generated by builders, municipalities, and vendors. A specification may be generated by a builder to correspond to a plan and then be customized by community (project/phase/community). Blocks or category blocks that are used by a municipality may be automatically added to a plan by the builder. After being generated, the specification may be transmitted to all vendors (also referred to as contractors) who receive bid requests. Once the specification is copied down to an account of a vendor, the vendor (e.g., through the trade interface (112) of FIG. 1A) may add additional blocks, category blocks, and items. The vendor may not remove or modify blocks created by the builder or municipality. The blocks (149) form a uniform way to standardize the building process from the bidding process to the individual construction phases throughout the entire home building process.

The category blocks (156) may be added to the specifications (155). Each specification may have multiple category blocks from the category blocks (156).

A series (a selection of one or multiple specific parts) may be applied to a specification. Applying a series replaces placeholders within the specification with the selections in the series.

Individual specifications may be shared with vendors. As an example, a builder may use the builder interface (102) (of FIG. 1A) to generate a specification that is transmitted to the trade interface (112) (of FIG. 1A) to share the specification with the vendor.

The specifications (155) may have versions that are identified with a version identifier. Multiple homes may use the same specification with the specification for each home being uniquely identified with a version identifier.

Changes to a specification may be pushed down to a vendor (e.g., to a contractor) while a task is in progress. For example, a plumbing vendor may have started work on a house and the specification is changed to specify a different faucet for installation into the home.

Builders and vendors may create templates for the specifications (155). The templates for the specifications (155) facilitate the creation of multiple specifications that may be the same for different homes. A template works like a specification that will let builders identify block selections that are missing in the current specification.

Specification templates may be shared. For example, different communities may have shared templates to build houses in the different communities using the same plans and blocks.

Specification templates may be acquired from a web store. The web store may be accessible to multiple builders through the builder interface (102) (of FIG. 1A).

Specification templates may be copied. For example, a specification may be copied from one community to another and may then be customized for the second community.

Changes to a specification template may be pushed to the plans created from the specification template. For example, a task in a specification template initially estimated to take 1 day may be changed to take 2 days, which gets pushed out to each of the specifications and plans based on the template and using the task.

The blocks (149) are customizable templates for individual pieces that form a foundation for the worksite information management application (142) (of FIG. 1A). The blocks (149) provide a standard vehicle for data to be communicated between the different interfaces and devices of the system (100) (of FIG. 1A). Each block defines a single specific aspect or task of a job that, when combined, create a job specification. Each block may be composed of a variety of details including drawings, images, materials, placeholders, task steps. Builders, vendors, municipalities and other parties related to the construction process may create and customize blocks with individual specifications. The specifications (155) (containing a group of blocks) may be pushed down to vendors to request bids. Blocks sent to vendors (e.g., contractors) may be pushed to their vendors (e.g., to subcontractors). The blocks that are passed down to a vendor or related party may be added to but may not be changed by the vendor receiving the block. The blocks include (149) include the category blocks (156), the item blocks (157), the part blocks (158), and the task blocks (159).

The category blocks (156) are templates used to arrange multiple blocks into logical groups that can be assigned to a vendor trade class (e.g., to a plumber or electrician using the trade interface (112) of FIG. 1A). Once a category block (of the category blocks (156)) is added to a specification (of the specifications (155)) the category block may be customized to include the specific item blocks (from the item blocks (157)) for a job. The category blocks (156) may be added to specification templates to enable builders to quickly build out multiple specifications (of the specifications (155)) and to avoid missing key trades and cost codes used by a specification.

Each different type of trade (e.g., plumbing, electrical, HVAC (heating, ventilation, and air conditioning)) may be part of a different category block. Separating the different trades into different category blocks allows for the costs of individual trades to be rolled up and determined independently.

The item blocks (157) are templates used to map parts and services to cost codes. Each item block may be assigned a cost code and contain a set of part blocks (from the part blocks (158)) that define what actions and materials are required for a job. The item blocks (157) may be created and customized individually by organizations using the system (100) and may also be shared through a web store.

The part blocks (158) are templates used to map specific placeholders, materials, and task blocks (from the task blocks (159)) to item blocks (from the item blocks (157)). The part blocks (158) allow item costs to be rolled up into a single cost code for an item block from the item blocks (157).

Placeholders allow part blocks to specify material categories without having to specify the specific material. For example, a placeholder may be a generic faucet instead of referencing a specific faucet from the item master. Placeholders provide a unique ability for builders and trades to create a generic plan and then later use a series (a selection of specific parts) to override the placeholder items with specific items defined by the series.

The task blocks (159) are templates that define a set of steps that are added to scheduled tasks. By adding tasks blocks to a specification, the system (100) (of FIG. 1A) may automatically identify the tasks to be created for the jobs of the specification and apply automation rules for assignment and scheduling.

Turning to FIG. 2, the system (200) implements multiple interfaces to monitor and track punch items for a worksite. The system (200) processes input (including the images (222)) from the client devices A (202) and B (207) through N (209) with the server (212) to generate the outputs presented to the client devices A (202) and B (207) through N (209). The system (200) includes the server (212), the client devices A (202) and B (207) through N (209), and the repository (270).

The server (212) is a computing system (further described in FIG. 12A). The server (212) may include multiple physical and virtual computing systems that form part of a cloud computing environment. In one embodiment, execution of the instructions, programs, and applications of the server (212) is distributed to multiple physical and virtual computing systems in the cloud computing environment. The server (212) may include the server application (215).

The server application (215) is a collection of programs with instructions that may execute on multiple servers of a cloud environment, including the server (212). The server application (215) may implement one or more of the applications (142), (144), and (145) of FIG. 1A. The server application (215) processes the images (222) to update the checklist items (235) and generate the notifications (240). In one embodiment, the server application (215) hosts websites and may serve structured documents (hypertext markup language (HTML) pages, extensible markup language (XML) pages, JavaScript object notation (JSON) files and messages, etc.) to interact with the client devices A (202) and B (207) through N (209). Requests from the client devices A (202) and B (207) through N (209) may include the images (222) and be processed to generate the notifications (240) and generate updates to the checklist items (235) and the checklist views (232). The notifications (240), the checklist items (235), and the checklist views (232) are presented to the client devices A (202) and B (207) through N (209). The server application (215) may include the image controller (225), the checklist controller (230), and the notification controller (238).

The images (222) are images received from the client devices A (202) and B (207) through N (209). The images (222) include images of a worksite that show the status of a task performed at the worksite. For example, the worksite may be a residential home, and the tasks may include the tasks performed to build the home, including concrete pouring, plumbing work, framing, electrical work, sewage installation, etc. In one embodiment, the images (222) include task images, review images, and punch images that may be from worker interfaces, trade interfaces, builder interfaces, etc., that are operated by the client devices A (202) and B (207) through N (209). The images (222) may be input to the image controller (225).

The image controller (225) is a collection of hardware and software components with programs of instructions that may operate on the server (212). The image controller (225) processes the images (222) that are received from the client devices A (202) and B (207) through N (209). In one embodiment, the image controller (225) may add information and watermarks to the images (222). In one embodiment, the image controller (225) may generate the thumbnails (228).

The thumbnails (228) are images generated from the images (222). The thumbnails (228) have reduced resolutions compared to the images (222) to be displayed on a smaller portion of the screens of the client devices A (202) and B (207) through N (209). The thumbnails (228) may be presented with the checklist items (235).

The checklist controller (230) is a collection of hardware and software components with programs of instructions that may operate on the server (212). The checklist controller (230) processes the messages received from the client devices A (202) and B (207) through N (209), which include the images (222). In response to the messages from the client devices A (202) and B (207) through N (209), the checklist controller (230) updates the checklist items (235) and the checklist views (232).

The checklist views (232) are collections of the checklist items (235). A checklist view may be generated for each of the client devices A (202) and B (207) through N (209) and presented to the client devices A (202) and B (207) through N (209).

The checklist items (235) are items shown in the checklist views (232). A checklist item may include several pieces of data including images, notifications, and text.

The notification controller (238) is a collection of hardware and software components with programs of instructions that may operate on the server (212). The notification controller (238) generates the notifications (240) in response to updates to the data in the system (200).

The notifications (240) are messages that may be pushed to, and displayed by, the client devices A (202) and B (207) through N (209). As an example, a notification may identify that additional work is requested for a worksite (i.e., a punch item). A notification may be sent to and displayed by a trade interface.

The client devices A (202) and B (207) through N (209) are computing systems (further described in FIG. 12A) and may be embodiments of the client devices A (101) through D (131) of FIG. 1A. For example, the client devices A (202) and B (207) through N (209) may be desktop computers, mobile devices, laptop computers, tablet computers, server computers, etc. The client devices A (202) and B (207) through N (209) include hardware components and software components that operate as part of the system (200). The client devices A (202) and B (207) through N (209) communicate with the server (212) to access, manipulate, and view services and information hosted by the system (200). In one embodiment, the client devices A (202) and B (207) through N (209) may communicate with the server (212) using standard protocols and file types, which may include hypertext transfer protocol (HTTP), HTTP secure (HTTPS), transmission control protocol (TCP), internet protocol (IP), hypertext markup language (HTML), extensible markup language (XML), secure sockets layer (SSL), transport layer security (TLS), etc. The client devices A (202) and B (207) through N (209) respectively include the user applications A (205) and B (208) through N (210).

The client applications A (205) and B (208) through N (210) may each include multiple programs respectively running on the client devices A (202) and B (207) through N (209). The client applications A (205) and B (208) through N (210) may implement the applications of the builder interface (102), the trade interface (112), the worker interface (122), and the inspector interface (132) of FIG. 1A. The client applications A (205) and B (208) through N (210) may be native applications, web applications, embedded applications, etc. In one embodiment, the client applications A (205) and B (208) through N (210) include web browser programs that display web pages from the server (212).

As an example, the user application A (205) may implement a builder interface that identifies a punch item to the system (200). The server application (215) receives the punch item with an image and updates the checklist views (232). The checklist views (232) that are updated may be transmitted back to, and displayed by, the client devices A (202) and B (207) through N (209). The notifications (240) may also be generated from the updates and presented to the client devices A (202) and B (207) through N (209).

The repository (270) is a computing system that may include multiple computing devices in accordance with the computing system (1200) and the nodes (1222) and (1224) described below in FIGS. 12A and 12B. The repository (270) may be hosted by a cloud services provider that also hosts the server (212). The cloud services provider may provide hosting, virtualization, and data storage services as well as other cloud services to operate and control the data, programs, and applications that store and retrieve data from the repository (270). The data in the repository (270) includes the image data (272), checklist data (275), and notification data (278).

The image data (272) includes the images used by the system (200). The image data (272) includes the images (222) and the thumbnails (228).

The checklist data (275) includes information about tasks performed at worksites. The checklist data (275) includes the information presented in the checklist views (232) and the checklist items (235).

The notification data (278) includes the messages and data sent through the system (200) in response to updates from the client devices A (202) and B (207) through N (209). The notification data (278) includes the notifications (240).

Although shown using distributed computing architectures and systems, other architectures and systems may be used. In one embodiment, the server application (215) may be part of a monolithic application that implements worksite information management. In one embodiment, the client applications A (205) and B (208) through N (210) may be part of monolithic applications that implement worksite information management without the server application (215).

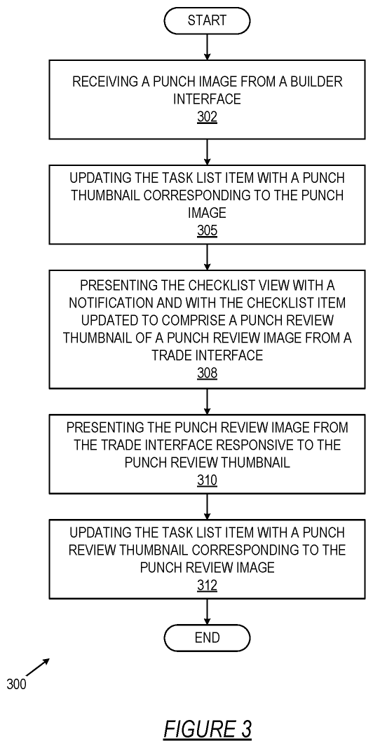

Turning to FIG. 3, the process (300) processes punch items using a builder interface. The process (300) may be performed by a computing device interacting with one or more additional computing devices. For example, the process (300) may execute on a server responding to one or more client devices.

At Step 302, a punch image is received from a builder interface. The punch image depicts a worksite corresponding to a task of a checklist item presented in a checklist view. In one embodiment, the punch image is received by a client application operating the builder interface on a client device. In one embodiment, the punch image is received by a server application operating on a server that receives the punch image from a client device operating the builder interface.

At Step 305, the checklist item is updated with a punch thumbnail corresponding to the punch image. In one embodiment, the punch thumbnail is generated from the punch image by reducing a resolution of the punch image. In one embodiment, the task item is updated by displaying the thumbnail and displaying a count icon on the thumbnail that identifies the number of images associated with the checklist item.

At Step 308, the checklist view is presented with a notification and with the checklist item updated to include a punch review thumbnail of a punch review image from a trade interface. In one embodiment, the punch review thumbnail is generated from the punch review image. In one embodiment, the punch review image is captured by the trade interface and transmitted to a server.

In one embodiment, the checklist view is presented with a header with multiple identifiers. The identifiers may include a property identifier, a date identifier, an application identifier, a community identifier, and a task identifier. In one embodiment, the property identifier includes a physical address of a worksite. In one embodiment, the application identifier identifies the program presenting the checklist view. In one embodiment, the community identifier identifies a name of a group of worksites, i.e., of a community. In one embodiment, the task identifier identifies one or more of a role of a person that performed the task (“crew”, “super”, etc.) and a description of a phase of construction (e.g., “top out”).

In one embodiment, the checklist view is presented with the checklist item replaced with a set of icons. In one embodiment, the set of icons includes a photo icon, a punch icon, and a null icon.

In one embodiment, selection of the photo icon brings up a camera application. The camera application may be used to capture the punch image responsive to selection of the photo icon.

In one embodiment, selection of the punch icon brings up a punch menu. The punch menu may be used to enter data about a punch item responsive to selection of the punch icon. The data, also referred to as a punch description, may include a text description of the punch item, a type of the punch item, and a trade identifier. The text description of the punch item may describe work to be performed to resolve the punch item. The type of a punch item may specify if the punch item was generated with a builder interface or with a trade interface. The trade identifier may identify the type of trade (plumbing, concrete pour, electrical, etc.) for the trade interface to which a notification will be sent. The trade identifier may be included in a trade selection generated from interacting with the punch menu.

At Step 310, the punch review image from the trade interface is presented responsive to the punch review thumbnail.

In one embodiment, a punch task image from a worker interface is presented responsive to the punch review image. In one embodiment, a user may swipe left or right to bring up different images, which may be sorted and accessed chronologically. For example, the images may include, in chronological order,
the task image (to show completion of the original work),
the review image (to show the original work was reviewed),
the punch image (to identify additional work to be performed for the punch item),
the punch task image (to show performance of the work for the punch item), and
the punch review image (showing that the work performed for the punch item has been reviewed).

The images may be sorted left-to-right (older images to the left and newer images to the right) or sorted right-to-left (older images to the right and newer images to the left). When the punch review image is displayed and the system uses a right-to-left ordering, swiping left on the punch review image may display the punch task image, which is chronologically previous and was captured prior to capture of the punch review image.

In one embodiment, a punch image from the builder interface is presented responsive to the punch task image. For example, a user may swipe (e.g., to the left) on the punch task image to show the punch image from the builder interface, which may be the chronologically previous image.

In one embodiment, a review image from the trade interface is presented responsive to the punch image. For example, a user may swipe left on builder punch image to show trade review image (i.e., the review image from the trade interface).

In one embodiment, the task image from the worker interface is presented responsive to the review image. For example, a user may swipe left on the trade review image to show crew task image.

At Step 312, the checklist item is updated with a punch review thumbnail corresponding to the punch review image. The punch review thumbnail may replace the previous thumbnail and a thumbnail count may be updated to identify the number of images associated with the checklist item.

In one embodiment, an icon of the checklist item is updated responsive to selection of a punch icon. For example, selecting the punch icon may trigger a visual change of the punch icon from a green check to a red x.

In one embodiment, an icon of the checklist item is updated responsive to the notification. For example, after receiving a notification indicating additional work is to be performed at the worksite for the checklist item, an icon for the checklist item may be updated from a completed (e.g., green) checkmark to an incomplete (e.g., white) checkmark.

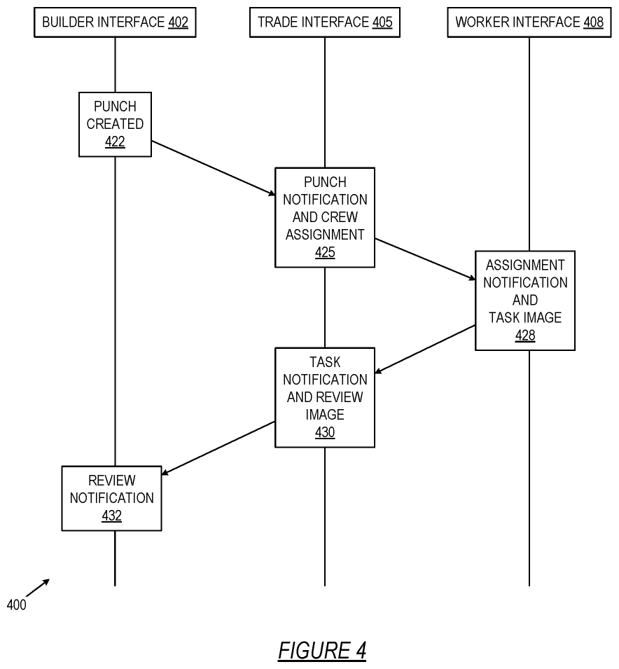

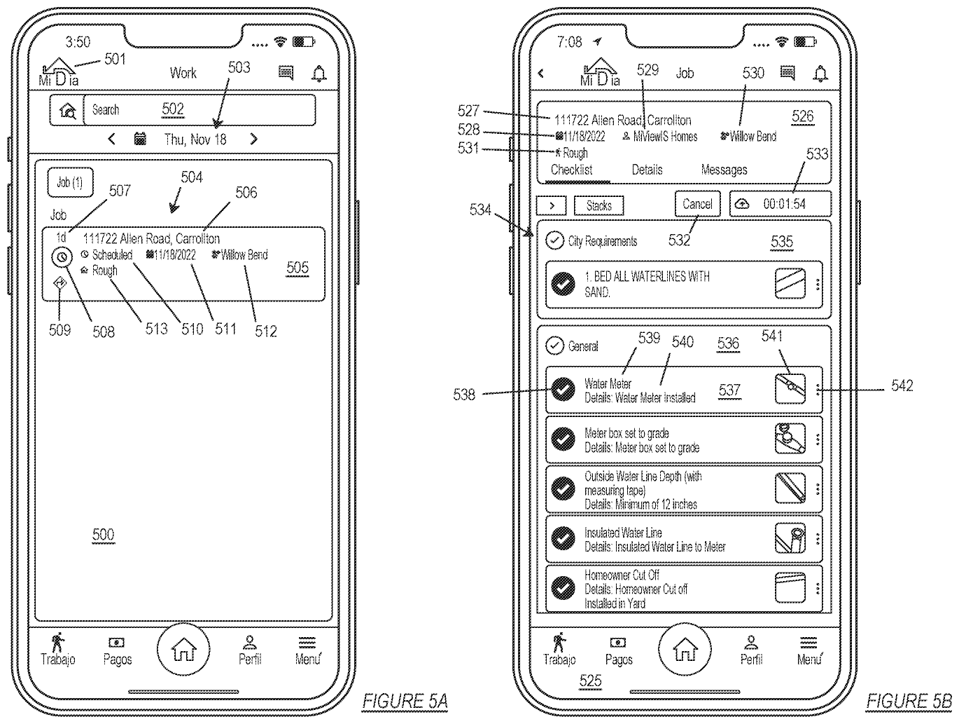

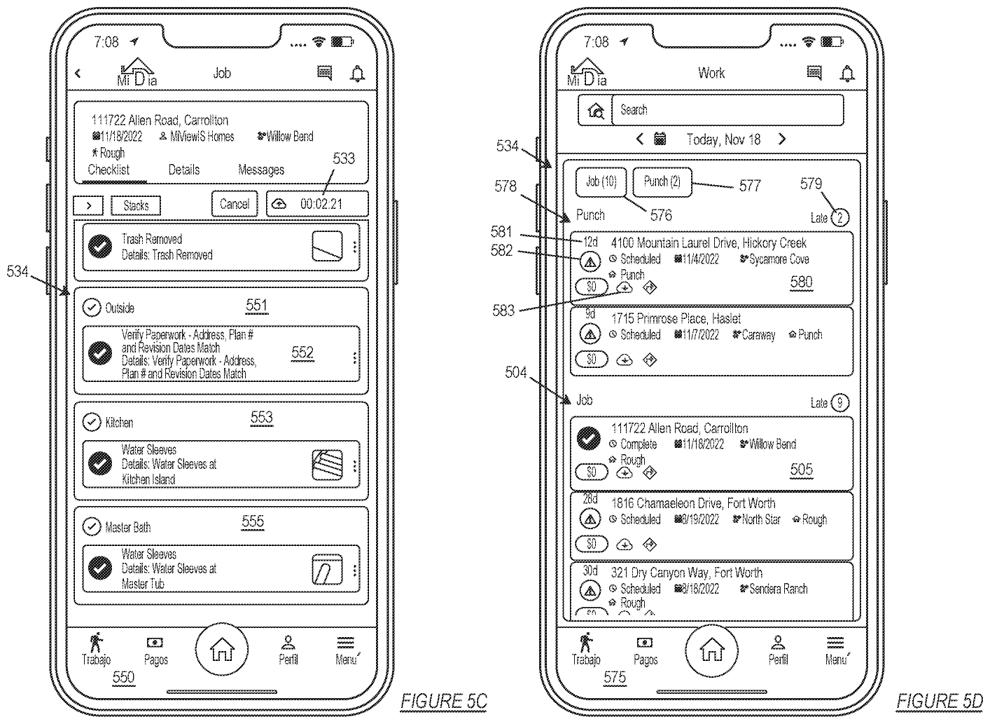

Turning to FIG. 4, the sequence (400) executes on the devices of a worksite information management system that includes client devices that execute the builder interface (402), the trade interface (405), and the worker interface (408). The client devices connect to a server and the worksite information system passes messages between the components to generate and resolve punch lists.

At Step 422, a punch item is created upon interaction with the builder interface (402). For example, a user may review a checklist item and see incomplete work in an image for the checklist item. A punch menu is displayed that captures information about the punch item that may include an image for the punch item (also referred to as a punch image). The image for the punch item may be a previous review image captured with the trade interface (405). A punch notification for the punch item is generated and transmitted to the trade interface (405).

At Step 425, the punch notification is displayed. A user of the trade interface (405) may further interact with the trade interface (405) to create a crew assignment. The crew assignment a collection of data that identifies a crew for performing work for the punch item. An assignment notification for the crew assignment is created and transmitted to the worker interface (408).

At Step 428, the worker interface (408) receives the assignment notification. The worker interface (408) may display the assignment notification along with the punch image from the builder interface (402). After performing the work for the punch item, the worker interface (408) captures a punch task image for the punch item that shows completion of the work. The punch task image is transmitted to the trade interface (405) with a task notification.

At Step 430, the trade interface (405), receives the task notification. The task notification may be displayed with the punch task image, which was captured with the worker interface (408). The user of the trade interface (405) may inspect the worksite and capture a punch review image that further shows completion of the work. A review notification is generated that may be transmitted to the builder interface (402).

At Step 432, the review notification is presented by the builder interface (402). The punch review image may be presented in response to selection of the review notification. Responsive to receiving the review notification, the punch item may be identified as complete.

FIG. 5A through FIG. 5D illustrate the use of a worker interface navigated by a worker (also referred to as a crew member) to document work performed at a worksite. Turning to FIG. 5A the worker interface (500) is displayed on a client device. The worker interface (500) includes multiple interface elements.

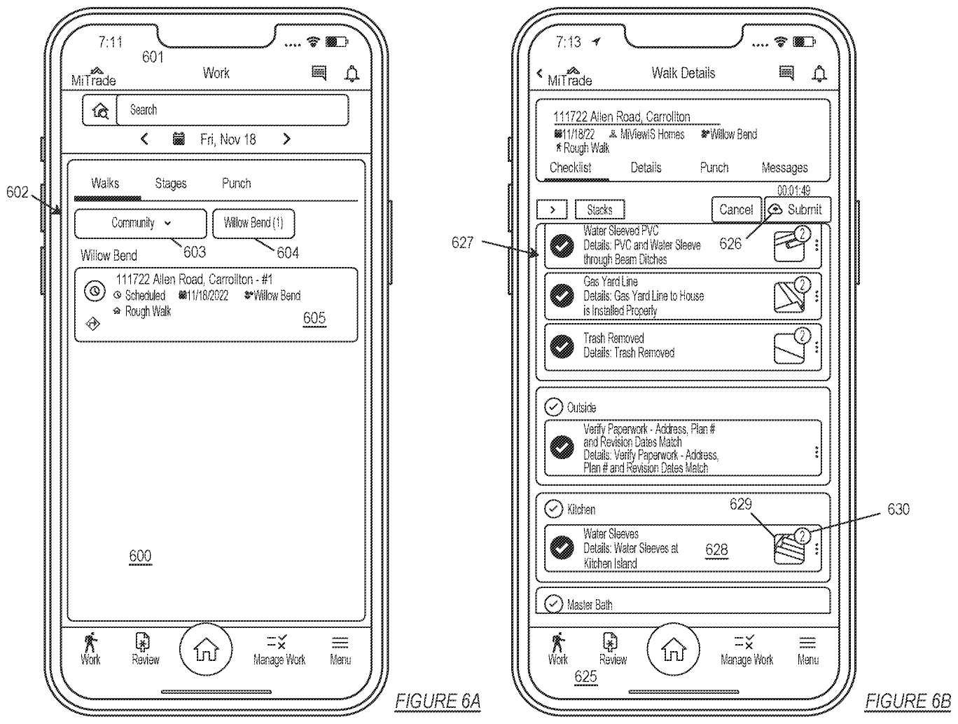

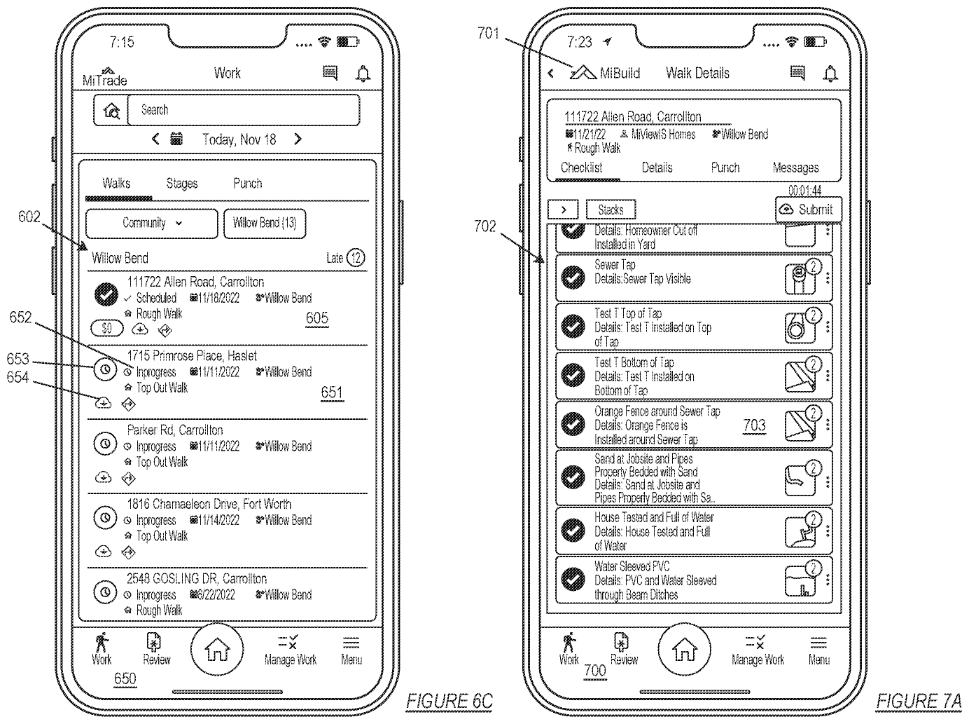

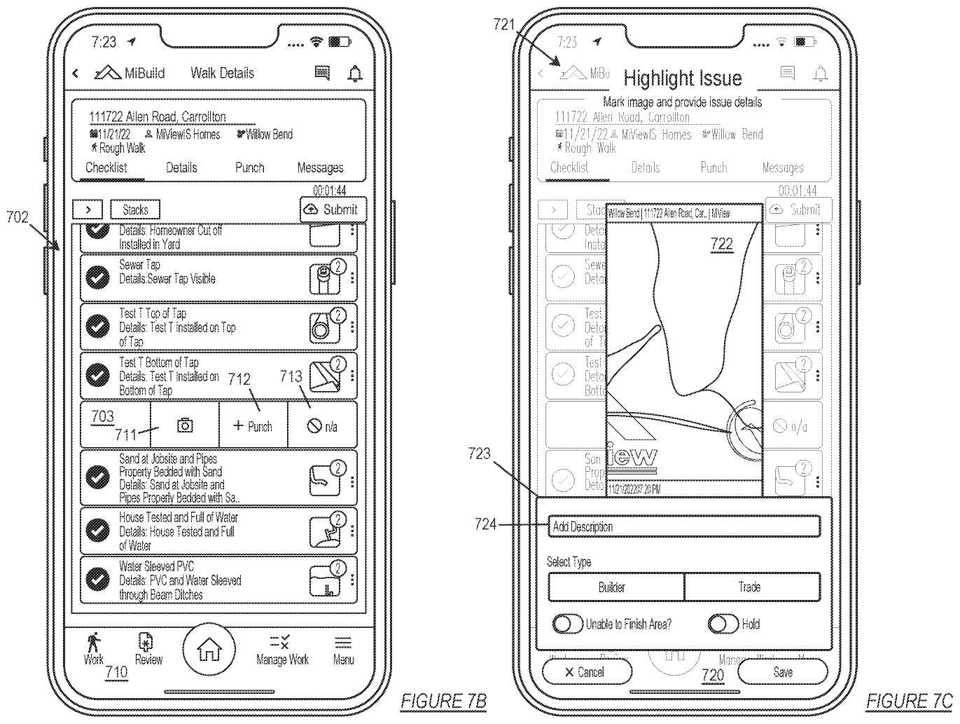

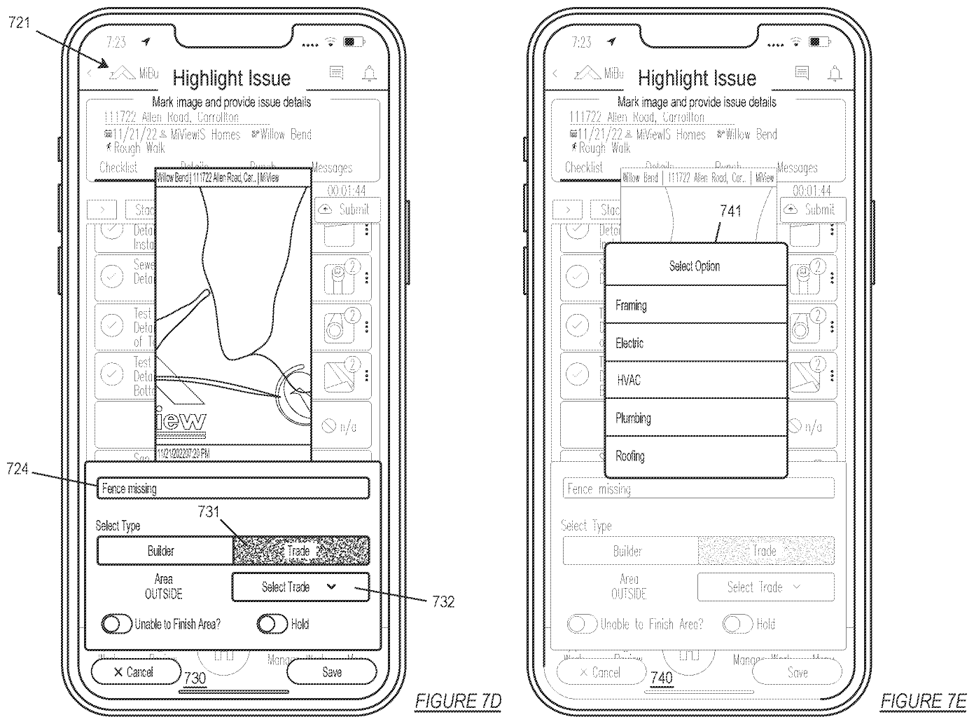

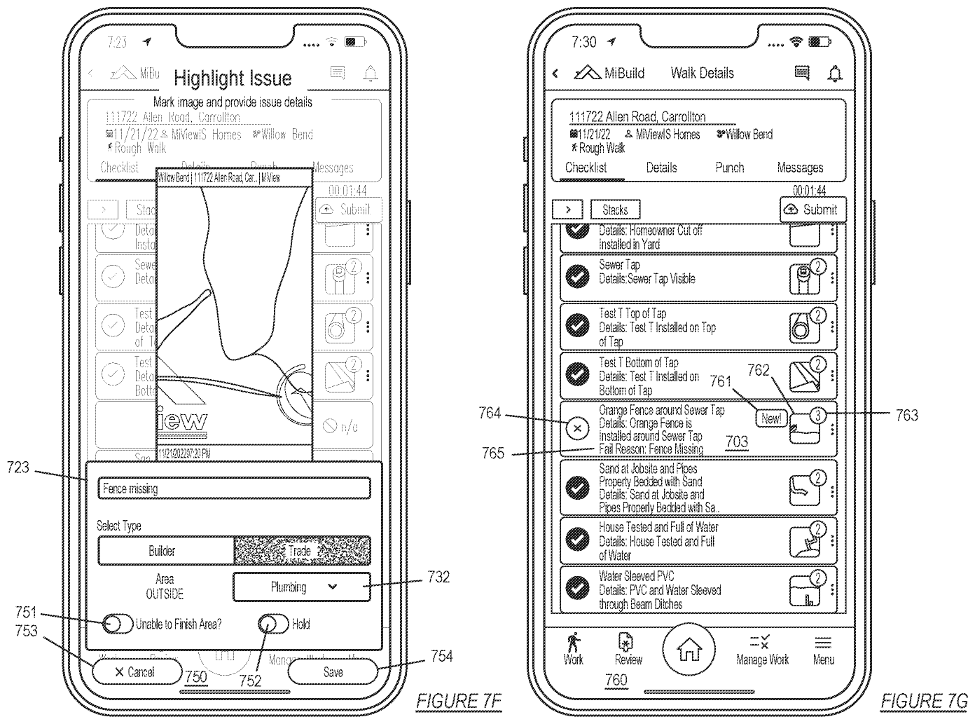

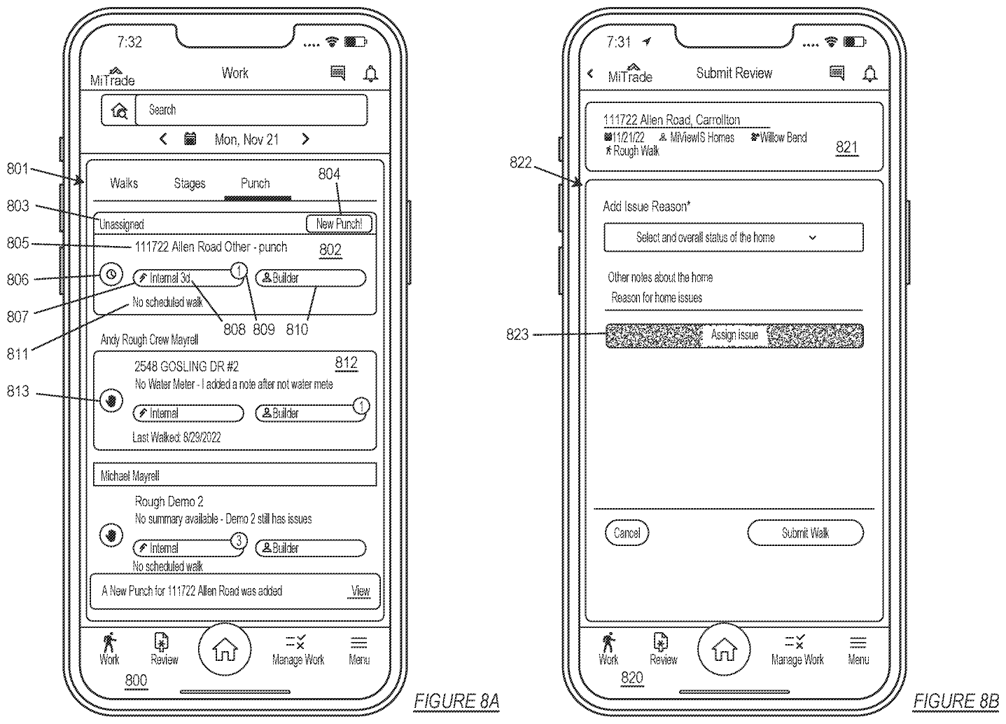

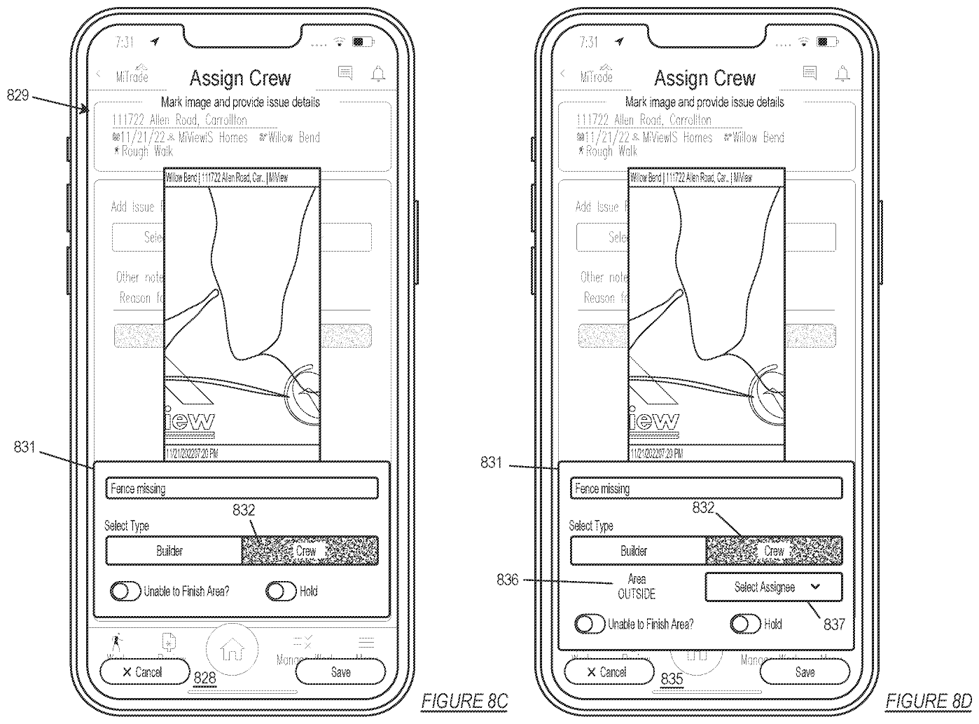

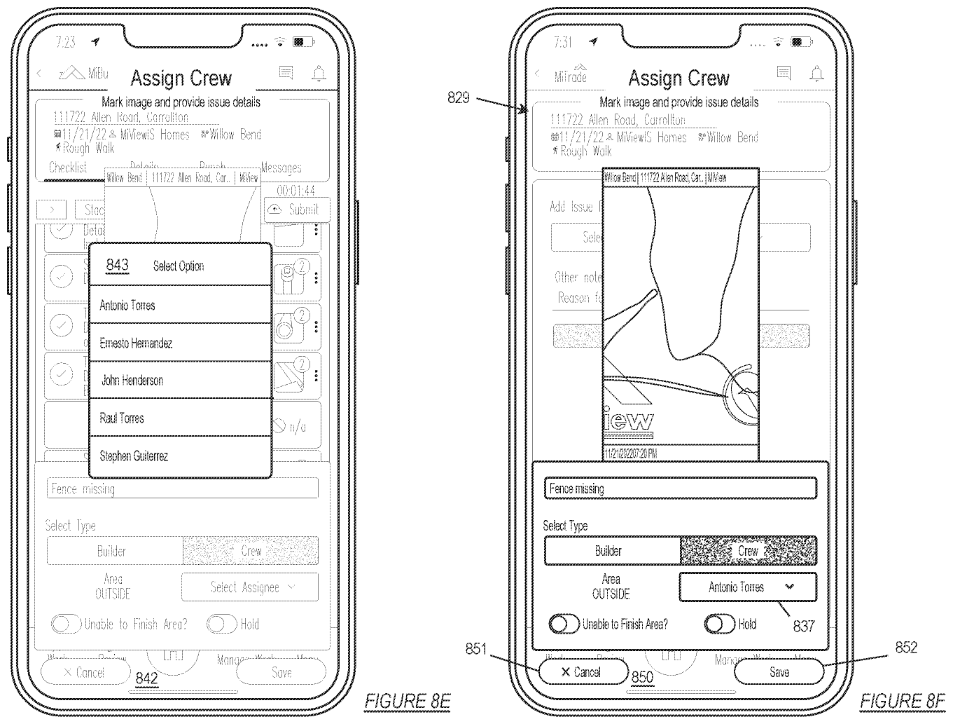

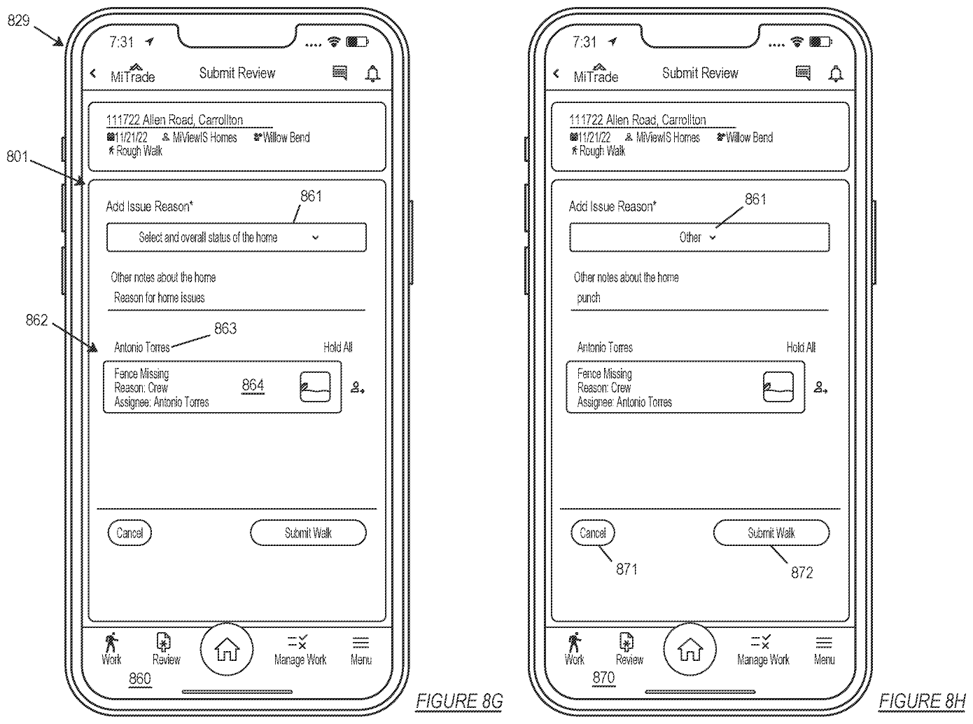

The worker interface identifier (501) is an interface element of the worker interface (500). The worker interface identifier (501) includes an image with text that distinguishes the worker interface (500) from other different types of user interfaces (e.g., from the trade interface (600) of FIG. 6A and the builder interface (700) of FIG. 7A).

The search element (502) is an interface element of the worker interface (500). The search element (502) filters the worksite items displayed in the job list (504). The search element (502) may receive text from a user that is used to identify and display worksite items based on information corresponding to the worksite items. For example, when the text “111722 Allen” is entered to the search element (502), the text “111722 Allen” is matched to the text in the worksite identifier (506) of the worksite item (505) and the worksite item (505) is displayed in the job list (504).

The date element (503) is an interface element of the worker interface (500). The date element (503) filters the worksite items displayed in the job list (504) based on a date. The date selected with the date element (503) may identify the latest due date for worksite items displayed in the job list (504). For example, the selected date of “Thu, Nov 18” may be used to display worksite items with due dates on or before the selected date. In one embodiment, the worksite items may be filtered to show the worksite items with due dates that match the selected date.

The job list (504) is an interface element of the worker interface (500). The job list (504) displays worksite items (including the worksite item (505)) that identify work for the user of the client device displaying the worker interface (500).

The worksite item (505) is an interface element of the worker interface (500). The worksite item (505) includes and displays several pieces of information.

The worksite identifier (506) is an interface element in the worksite item (505) of the worker interface (500). The worksite identifier (506) displays information that distinguishes one worksite from another worksite. For example, the worksite identifier (506) includes the text “111722 Allen Road, Carrollton”, which is a physical address for the worksite corresponding to the worksite item (505).

The days due identifier (507) is an interface element in the worksite item (505) of the worker interface (500). The days due identifier (507) identifies the due date for the worksite item (505) in relation to the present date. For example, the text “1d” when shaded green indicates that the worksite item (505) is due to be completed within 1 day. When shaded red, the text “1d” in the days due identifier (507) indicates that the due date is one day past due.

The worksite item icon (508) is an interface element in the worksite item (505) of the worker interface (500). The worksite item icon (508) provides a visual indication of the status of the worksite item (505). In one embodiment, a blue stopwatch indicates that work is scheduled that has not been completed. A red warning sign (e.g., an exclamation point in a triangle), may indicate that the worksite item (505) may be past due. A green checkmark may indicate that the scheduled work has been completed.

The navigation icon (509) is an interface element in the worksite item (505) of the worker interface (500). The navigation icon (509) indicates that turn-by-turn directions are available to bring the location of the client device to the location of the worksite (which may be provided in the worksite identifier (506)). In one embodiment, selecting the navigation icon (509) may bring up a user interface that shows a map that provides turn-by-turn directions.

The status identifier (510) is an interface element in the worksite item (505) of the worker interface (500). The status identifier (510) includes text and an icon and identifies the status of the work at the worksite corresponding to the worksite item (505). In one embodiment, the status may be “Scheduled” and “Complete”. The “Scheduled” status may indicate that work has been scheduled but not completed for a worksite item. The “Complete” status may indicate that the work scheduled has been completed.

The date identifier (511) is an interface element in the worksite item (505) of the worker interface (500). The date identifier (511) includes text and an icon and identifies a date for the worksite item (505). The date identified by the date identifier (511) may be the date that the worksite item (505) is scheduled to be completed.

The community identifier (512) is an interface element in the worksite item (505) of the worker interface (500). The community identifier (512) includes text and an icon and identifies a community corresponding to the worksite. A community is a collection of worksites that correspond to a single builder.

The phase identifier (513) is an interface element in the worksite item (505) of the worker interface (500). The phase identifier (513) includes text and an icon and identifies the phase for the worksite corresponding to the worksite item (505). In one embodiment, phases include “Rough In”, “Box and Wrap”, “Top Out”, “Trim”, etc. In one embodiment, the “Rough In” phase identifies a work stage that includes installation of plumbing before the foundation is poured. In one embodiment, the “Box and Wrap” phase identifies a work stage that includes preparation of the plumbing from the “Rough In” phase for the foundation to be poured. In one embodiment, “Top Out” phase identifies a work stage that includes installation of pipes in the walls after the foundation is poured and the frame of the structure at the worksite is built. In one embodiment, “Trim” phase identifies a work stage that includes installation of fixtures, including bathtubs, faucets, showers, sinks, toilets, etc.

Turning to FIG. 5B, the worker interface (525) is displayed after selecting the worksite item (505) from FIG. 5A. The worker interface (525) includes several interface elements, including the checklist header (526) and the checklist view (534) with several checklist items.

The checklist header (526) is an interface element of the worker interface (525). The checklist header (526) displays information about a worksite using multiple interface elements.

The worksite identifier (527) is an interface element in the checklist header (526) of the worker interface (525). The worksite identifier (527), similar to the worksite identifier (506) of FIG. 5A, displays information that distinguishes one worksite from another worksite.

The date identifier (528) is an interface element in the checklist header (526) of the worker interface (525). The date identifier (528) includes text and an icon and identifies a date for completion of the items of the checklist view (534).

The builder identifier (529) is an interface element in the checklist header (526) of the worker interface (525). The builder identifier (529) includes text and an icon and identifies an entity. In one embodiment, the entity identified is a builder that is developing the worksite using a worksite information management system.

The community identifier (530) is an interface element in the checklist header (526) of the worker interface (525). The community identifier (530), like the community identifier (512) of FIG. 5A, includes text and an icon and identifies a community corresponding to the worksite.

The phase identifier (531) is an interface element in the worksite item (505) of the worker interface (525). The phase identifier (531), like the phase identifier (513) of FIG. 5A, includes text and an icon and identifies the phase for the worksite.

The cancel button (532) is an interface element of the worker interface (525). The cancel button (532) may be selected to return to the worker interface (500) of FIG. 5A without updating the checklist view (534).

The submit button (533) is an interface element of the worker interface (525). The submit button (533) includes an icon and a timer. The icon includes an image of a cloud and an up arrow to indicate that changes made to the checklist view (534) will be uploaded to a server. The timer identifies the amount of time that has passed since starting to work on the checklist view (534), e.g., by selecting the worksite item (505) from FIG. 5A.

The checklist view (534) is an interface element of the worker interface (525). The checklist view (534) may include multiple checklists of items, including the city checklist (535) and the general checklist (536). Additional checklists may correspond to areas of a house, which may be labeled “Outside”, “Garage”, “Kitchen”, “Master Bathroom”, “Utility”, “Bath #2”, “Bath #3”, Powder Bath, etc.

The city checklist (535) is an interface element in the checklist view (534) of the worker interface (525). The city checklist (535) includes a checklist identifier with the text “City Requirements” and a checklist item.

The general checklist (536) is an interface element in the checklist view (534) of the worker interface (525). The general checklist (536) includes a checklist identifier with the text “General” and multiple checklist items, including the checklist item (537).

The checklist item (537) is an interface element of the general checklist (536) of the worker interface (525). The checklist item (537) provides information about a task to be performed at a worksite. The checklist item (537) includes multiple interface elements.

The item icon (538) is an interface element of the checklist item (537) of the worker interface (525). The item icon (538) identifies a status of the checklist item (537). In one embodiment, the item icon (538) may include a green background with a white check to indicate that the task is complete. In one embodiment, the item icon (538) may include a white background with a green check to indicate that the task is not complete. Selecting the item icon (538) may toggle between different states for the checklist item (537), including a “complete” state and an “incomplete” state.

The item identifier (539) is an interface element of the checklist item (537) of the worker interface (525). The item identifier (539) includes text that identifies the work performed for the checklist item (537).

The item description (540) is an interface element of the checklist item (537) of the worker interface (525). The item description (540) includes text that provides additional details regarding the work performed for the checklist item (537).

The item thumbnail (541) is an interface element of the checklist item (537) of the worker interface (525). The item thumbnail (541) may be generated from an image captured by the client device executing the worker interface (525) in which the captured image shows completion of the work at the worksite for the checklist item (537). The item thumbnail (541) does not include a counter, which indicates that a single image is associated with the checklist item (537). In one embodiment, the checklist item (537) may not be identified as completed without capturing an image of the work performed, from which the item thumbnail (541) is generated and displayed.

The dot element (542) is an interface element of the checklist item (537) of the worker interface (525). The dot element (542) may be selected to drag and drop the checklist item (537) to a different position in the general checklist (536).

Turning to FIG. 5C, the worker interface (550) is updated from the worker interface (525) of FIG. 5B after scrolling the checklist view (534). Scrolling the checklist view (534) reveals additional checklists and checklist items.

The checklist view (534) includes the outside checklist (551), the kitchen checklist (553), and the master bath checklist (555), which are checklists for additional areas at the worksite.

The checklist item (552) is an interface element of the outside checklist (551) of the worker interface (525). The checklist item (552) is an item in which an image is not captured to complete the checklist item (552).

Turning to FIG. 5D, the worker interface (575) is displayed after selection of the submit button (533) from the worker interface (550) of FIG. 5C. The worker interface (575) is an updated version of the worker interface (500) of FIG. 5A in which several interface elements are updated.

The job button (576) is displayed with a count (“10”) of the number of worksite items in the job list (504). When the job button (576) is active, selection of the job button (576) may automatically scroll the checklist view (534) to display the job list (504). The job button (576) may be active when the job list (504) is not displayed within the checklist view (534).

The punch button (577) operates similarly to the job button (576) and is displayed with a count (“2”) of the number of worksite items in the punch list (578). When the punch button (577) is active, selection of the punch button (577) may automatically scroll the checklist view (534) to display the punch list (578). The punch button (577) may be active when the punch list (578) is not displayed within the checklist view (534).

The punch list (578) is an interface element of the checklist view (534) of the worker interface (575). The punch list (578) is added to the checklist view (534) and indicates that after the worker interface (500) (of FIG. 5A) was displayed, two punch items were added to the worksite items for the user of the client device. The punch list (578) includes the overdue counter (579) and the worksite item (580).

The overdue counter (579) is an interface element of the punch list (578) of the worker interface (575). The overdue counter (579) includes text and an icon with a counter. The text and the icon may be colored red to indicate that there are a number or worksite items in the punch list (578) that are past their scheduled due dates (i.e., overdue). The text indicates that the counter identifies the number of worksite items that are overdue. As an example, the overdue counter (579) indicates that “2” items are overdue of the “2” punch items identified in the punch button (577).

The worksite item (580) is an interface element of the punch list (578) of the worker interface (575). The worksite item (580) identifies a worksite for which there is at least one punch item to address. The worksite item (580) includes multiple interface elements.

The days due identifier (581) is an interface element of the worksite item (580) of the worker interface (575). The days due identifier (581) is colored red and includes the text “12d” to indicate that the worksite item (580) is 12 days overdue.

The worksite item icon (582) is an interface element of the worksite item (580) of the worker interface (575). The worksite item icon (582) is also colored red and includes a warning sign to indicate that the worksite item (580) is overdue.

The offline icon (583) is an interface element of the worksite item (580) of the worker interface (575). The offline icon (583) includes images of a cloud and a down arrow. The offline icon (583) indicates that the information and data for the worksite item (580) have been downloaded to the client device and that a connection to a server is not needed to proceed with the worksite item (580). The information and data for proceeding with the worksite item (580) may include images, thumbnails, checklists, checklist item statuses, etc.

The job list (504) is updated (from FIG. 5A) to show additional worksite items. The job list (504) is further updated to include a counter to indicate that “9” of the “10” items in the job list (504) are overdue.

The worksite item (505) of FIG. 5D is updated from FIG. 5A. The updates to the worksite item (505) show that the tasks for the worksite item (505) are complete. With completion of the worksite item (505), a notification is sent to a client device executing a trade interface so that the work may be reviewed.

FIG. 6A through FIG. 6C illustrate the use of a trade interface navigated by a user that is a supervisor to review work performed at a worksite. Turning to FIG. 6A, the trade interface (600) is displayed on a client device. The trade interface (600) includes multiple interface elements.

The trade interface identifier (601) is an interface element of the trade interface (600). The trade interface identifier (601) includes an image with text that distinguishes the trade interface (600) from other different types of user interfaces (e.g., from the worker interface (500) of FIG. 5A and the builder interface (700) of FIG. 7A).

The walk list (602) is an interface element of the trade interface (600). The walk list (602) displays worksite items (including the worksite item (605)) that identify worksites to be reviewed for the user of the client device displaying the trade interface (600).

The community dropdown (603) is an interface element of the walk list (602) of the trade interface (600). The community dropdown (603), when selected, displays a list of community identifiers for the worksite items. Selection of a community identifier from the list of community identifiers displayed from selecting the community dropdown (603) may filter and display the worksite items that include the selected community identifier.

The community button (604) is an interface element of the walk list (602) of the trade interface (600). The community button (604) includes text (“Willow Bend”) and a number (“1”). The text identifies the community, and the number indicates the number of worksite items that include the community identifier of the community button (604). Selection of the community button (604) may filter and display the worksite items that include the selected community identifier.

The worksite item (605) is an interface element of the trade interface (600). The worksite item (605) includes and displays several pieces of information of a worksite to be reviewed by the user of the trade interface (600).

Turning to FIG. 6B, the trade interface (625) is displayed after selecting the worksite item (605) from FIG. 6A. The trade interface (625) includes several interface elements, including the checklist view (627), with several checklist items.

The submit button (626) is an interface element of the trade interface (625). The submit button (626) includes an icon and the text “submit”. A timer above the submit button (626) identifies the amount of time that has passed since starting to work on the checklist view (627), e.g., by selecting the worksite item (605) from FIG. 6A.

The checklist view (627) is an interface element of the trade interface (625). The checklist view (627) presents a number of checklist items, including the checklist item (628).

The checklist item (628) is an interface element of a kitchen checklist of the trade interface (625). The checklist item (628) provides information about a task to be reviewed at a worksite. The checklist item (628) includes multiple interface elements.

The thumbnail (629) is an interface element of the checklist item (628) of the trade interface (625). The thumbnail (629) is generated from a review image captured with the client device operating the trade interface (625).

The thumbnail counter (630) is an interface element displayed on the thumbnail (629) of the trade interface (625). The thumbnail counter (630) identifies the number of images that have been captured, and may be displayed, for the checklist item (628).

Turning to FIG. 6C, the trade interface (650) is displayed after selection of the submit button (626) from the trade interface (625) of FIG. 6B. The trade interface (650) is an updated version of the trade interface (600) of FIG. 6A in which several interface elements are updated. The walk list (602) is updated to include updates to worksite items and to include additional worksite items. The worksite item (605) is updated to indicate that the worksite item (605) is completed by changing the icon (to a green background with a white checkmark) and status indicator (to “Complete”).

The worksite item (651) is added to the walk list (602). The status identifier (652) of the worksite item (651) indicates that the worksite item (651) is “In Progress”, i.e., that the worksite item (651) has been started but has not been completed. The worksite item icon (653) includes an orange background and a stopwatch image to indicate the worksite item (651) is in progress. The offline icon (654) includes a cloud image in a yellow color and a white down arrow inside the cloud to indicate that the information and data for the worksite item (651) is being downloaded to the client device.

FIG. 7A through FIG. 7G illustrate the use of a builder interface navigated by a user that represents a builder to create a punch item based on work and review of a worksite. FIG. 7A through FIG. 7G may illustrate an implementation of Step 422 of FIG. 4. Turning to FIG. 7A, the builder interface (700) is displayed on a client device. The builder interface (700) includes multiple interface elements.

The builder interface identifier (701) is an interface element of the builder interface (700). The builder interface identifier (701) includes an image with text that distinguishes the builder interface (700) from other different types of user interfaces (e.g., from the worker interface (500) of FIG. 5A and the trade interface (600) of FIG. 6A).

The checklist view (702) is an interface element of the builder interface (700). The checklist view (702) presents a number of checklist items, including the checklist item (703) for which a punch item is to be created.

Turning to FIG. 7B, the builder interface (710) is updated from the builder interface (700) of FIG. 7A. After being selected (e.g., by a long press, a slide left, a slide right, etc.), the checklist item (703) of the checklist view (702) is updated with different interface elements.

The capture button (711) is an interface element displayed on the checklist item (703) of the builder interface (710). Selecting the capture button (711) initiates the capture of an image for the checklist item (703).

The punch button (712) is an interface element displayed on the checklist item (703) of the builder interface (710). Selecting the punch button (712) initiates the creation of a punch item for the checklist item (703).

The null button (713) is an interface element displayed on the checklist item (703) of the builder interface (710). In one embodiment, selecting the null button (713) reverts the checklist item (703) to a previous state that shows information about a task instead of showing the capture button (711), the punch button (712), and the null button (713).

Turning to FIG. 7C, the builder interface (720) is displayed after selection of the punch button (712) from FIG. 7B. The builder interface (720) is updated to include display of the punch creation view (721).

The punch creation view (721) includes interface elements to receive data for a punch item for the checklist item (703) of FIG. 7B. In one embodiment, the punch creation view (721) is overlaid onto the checklist view (702) (of FIG. 7B).

The punch image (722) is an interface element of the punch creation view (721) of the builder interface (720). The punch image (722) may be a newly captured image or a previously captured image. The punch image (722) may also be edited to include highlighting and markup. For example, on a mobile device, the user may use a finger to draw lines onto the punch image (722). In one embodiment, the punch image (722) includes a header and a footer. The header includes a community identifier (“Willow Bend”), a worksite identifier (“111722 Allen Road, Carr . . . ”), and an application identifier (“MiView”). The footer includes a date identifier (“11/21/2022 7:28 PM”). The punch image (722) may include a set of watermarks. For example, the watermarks of the punch image (722) may include watermarks that identify a provider of the application, a trade company, a builder company, etc.

The punch data capture view (723) is an interface element of the punch creation view (721). The punch data capture view (723) includes several interface elements to capture data about the punch item.

The punch description field (724) is an interface element of the punch data capture view (723). The punch description field (724) may be used to enter a description of the punch item.

Turning to FIG. 7D, the builder interface (730) is an updated view of the builder interface (720) of FIG. 7C. The builder interface (730) is updated to include the punch description text “Fence missing” in the punch description field (724).

The punch type selector (731) is an interface element of the punch data capture view (723). The punch type selector (731) is used to select the type of punch item, which may identify an entity responsible for performing work related to the punch item (e.g., to “fix” the punch item). The punch type selector (731) is updated to show a selection of the “Trade” punch type (and not the “Builder” punch type).

The trade type selector (732) is an interface element of the punch data capture view (723). The trade type selector (732) is used identify the type of trade for resolution of the punch item.

Turning to FIG. 7E, the builder interface (740) is an updated view of the builder interface (730) of FIG. 7D. The builder interface (740) is updated to display the trade option view (741).

The trade option view (741) is an interface element of the builder interface (740). The trade option view (741) presents a number of types of trades that may be selected to identify the type of trade for resolving the punch item for the checklist item (703) of FIG. 7A. The types include “Framing”, “Electric”, “HVAC” (heating, vacuum, and air conditioning), “Plumbing”, and “Roofing”. Other options may be available and displayed.

Turning to FIG. 7F, the builder interface (750) is an updated view of the builder interface (730) of FIG. 7D. The builder interface (750) is updated with information in the interface elements. The trade type selector (732) is updated to identify the “Plumbing” trade type is to be used to resolve the punch item.

The finish field (751) is an interface element of the punch data capture view (723). The finish field (751) captures data (e.g., a binary value) of whether the issue identified in the punch item prevents finishing work in an area of the worksite.

In one embodiment, a punch item may be marked “Unable to Finish Area” when something prevents work from being performed for one or multiple tasks in an area. The finish field (751) may be used instead of noting the same issue for several tasks that cannot be completed for the same reason. The issue causing the delay may be external to a particular trade. For example, a set of “Trim” tasks of a plumbing trade may not be able to be performed because the tile has not been installed.

The hold field (752) is an interface element of the punch data capture view (723). The hold field (752) captures data that identifies whether a hold is to be placed.

In one embodiment, a “Hold” may be marked when a trade is waiting before proceeding to complete a task. For example, a trade may wait for builder-supplied materials to be able to complete a task. For a “Hold”, the issue causing the delay may be external to the Trade.

The cancel button (753) is an interface element of the punch data capture view (723). In one embodiment, selection of the cancel button (753) cancels the creation of the punch item for the checklist item (703) of FIG. 7A and does not save the information captured about the punch item.

The save button (754) is an interface element of the punch data capture view (723). In one embodiment, selection of the save button (754) saves the information captured about the punch item for the checklist item (703) of FIG. 7A.

Turning to FIG. 7G, the builder interface (760) is an updated view of the builder interface (700) of FIG. 7A. The builder interface (760) includes updates to the interface elements of the checklist item (703).

The item notification icon (761) is an interface element of the checklist item (703). The item notification icon (761) is displayed to indicate that the checklist item (703) has been updated. The item notification icon (761) may be displayed until the checklist item (703) is selected. In one embodiment, the item notification icon (761) may be displayed until a timer (e.g., 30 minutes, 3 hours, 1 day, etc.) runs out. The time may be started at the time an update for the checklist item (703) is received by the system, which may be from other devices.

The thumbnail (762) is an interface element of the checklist item (703). In one embodiment, the thumbnail (762) is a lower resolution copy of the punch image (722) (of FIG. 7C).

The thumbnail counter (763) is an interface element of the checklist item (703). The thumbnail counter (763) is updated from “2” (in FIG. 7A) to “3” to indicate that “3” images are associated with the checklist item (703).

The item icon (764) is an interface element of the checklist item (703). The item icon (764) is updated to include a red background with a white “X” to indicate that the checklist item (703) is not complete and may correspond to additional work at the worksite.

The punch reason (765) is an interface element of the checklist item (703). In one embodiment, the punch reason (765) includes the text “Fail Reason: Fence missing”, which includes the text “Fence missing” captured with the punch description field (724) of FIG. 7D. The punch reason (765) is displayed when the checklist item (703) includes a punch item that is open and has not been resolved.

FIG. 8A through FIG. 8H illustrate the use of a trade interface navigated by a user that represents a supervisor to assign a punch item to a worker (also referred to as a crew or crew member). FIG. 8A through FIG. 8H may illustrate an implementation of Step 425 of FIG. 4. Turning to FIG. 8A, the trade interface (800) is an updated version of the trade interface (650) of FIG. 6C. The trade interface (800) displays several interface elements, including the punch list view (801).

The punch list view (801) is an interface element of the trade interface (800). The punch list view (801) displays a list of punch items, including the punch item (802) and the punch item (812).

The punch item (802) is an interface element in the punch list view (801) of the trade interface (800). The punch item (802) includes interface elements to display and capture information about the punch item (802).

The assignment identifier (803) is an interface element in the punch item (802) of the trade interface (800). The assignment identifier (803) displays the text “Unassigned” to identify a crew that is assigned to perform the work at the worksite for the punch item (802). The text “Unassigned” indicates that a crew has not been assigned to the punch item (802).

The item notification icon (804) is an interface element of the punch item (802). The item notification icon (804) is displayed to indicate that the punch item (802) has been updated. The item notification icon (804) may be displayed until the punch item (802) is selected. In one embodiment, the item notification icon (804) may be displayed until a timer (e.g., 30 minutes, 3 hours, 1 day, etc.) runs out. The time may be started at the time the punch item (802) is created within the system, which may be by other devices.

The worksite identifier (805) is an interface element of the punch item (802). The worksite identifier (805) displays information that distinguishes one worksite from another worksite and includes the text “111722 Allen Road, Carrollton”, which is a physical address for the worksite corresponding to the punch item (802).

The punch status icon (806) is an interface element of the punch item (802). The punch status icon (806) displays a visual status of the punch item (802). In one embodiment, the punch status icon (806) includes a blue background and a white stopwatch to indicate that the punch item (802) has not been started or has time remaining.

The internal resolution element (807) is an interface element of the punch item (802). The internal resolution element (807) is enabled (compared to the builder resolution element (810), which is disabled and greyed out) to indicate that the selection of the assignment of the punch item (802) is to be handled internally. For example, the crew may be selected by the user of the client device executing the trade interface (800).

The days due identifier (808) is an interface element of the punch item (802). In one embodiment, the days due identifier includes the text “3d” and is colored green to indicate that the punch item (802) had 3 days to be completed.

The punch counter (809) is an interface element of the punch item (802). The punch counter (809) provides a count of the number of worksite items for the worksite (identified by the worksite identifier (805)) for where additional work is to be performed. The additional work may be to correct previously performed work.

The builder resolution element (810) is an interface element of the punch item (802). The builder resolution element (810) is disabled and greyed out to indicate that the builder is not responsible for causing the punch issue.

The status element (811) is an interface element of the punch item (802). The status element (811) includes the text “No scheduled walk” and indicates a status for the punch item (802).

The punch item (812) is an interface element of the punch list view (801). The punch item (812) is for a different worksite than the punch item (802) and includes the punch status icon (813).

The punch status icon (813) is an interface element of the punch item (812). In one embodiment, the punch status icon (813) includes a purple background with a white hand to indicate that the item is “on hold” to the user of the client device executing the trade interface (800) for the punch item.

Turning to FIG. 8B, the trade interface (820) is an updated view of the trade interface (800) of FIG. 8A. The trade interface (820) includes the punch header (821) and the punch view (822).

The punch header (821) is an interface element of the trade interface (820). The punch header (821) provides information about the worksite where the work related to the punch item (802) (of FIG. 8A) is to be performed.

The punch view (822) is an interface element of the trade interface (820). The punch view (822) includes interface elements to capture information about the punch item (802) (of FIG. 8A).

The assignment element (823) is an interface element of the punch view (822). In one embodiment, the assignment element (823) is a button that, when selected, displays interface elements for assigning a punch item to a worker. Fields in the interface elements for assigning a punch item may be automatically filled in with default values that correspond to the values determined automatically by the system. For example, the name identifier for the worker to perform the work for the punch item (802) may identify the worker that performed the original work from which the punch item (802) was identified.

Turning to FIG. 8C, the trade interface (828) is an updated version of the trade interface (820) of FIG. 8B. The trade interface (828) includes the assignment view (829).

The assignment view (829) is an interface element of the trade interface (828). The assignment view (829) includes interface elements to receive data about a punch item. In one embodiment, the assignment view (829) is overlaid onto the punch view (822) (of FIG. 8B).

The image (830) is an interface element of the assignment view (829) in the trade interface (828). The image (830) may be a previously captured image. The image (830) may be edited to include highlighting and markup. For example, on a mobile device, the user may use a finger to draw lines onto the image (830). In one embodiment, the image (830) may be the punch image (722) of FIG. 7C.

The data capture view (831) is an interface element of the assignment view (829). The data capture view (831) includes several interface elements to capture data.

The type selector (832) is an interface element of the data capture view (831). In one embodiment, the type selector (832) is used to identify the type of selection for the assignment of a crew to a punch item. The type selector (832) includes the “Crew” option to let the user of the client device executing the trade interface (828) to assign a crew. The type selector (832) also includes a “Builder” to have the selection of the assignment of the crew be performed using a builder interface.

Turning to FIG. 8D, the trade interface (835) is an updated version of the trade interface (828) of FIG. 8C. The trade interface (835) is updated after interaction with the type selector (832).

The type selector (832) is updated to show that the “Crew” type has been selected. Selection of the “Crew” type triggers display of the area identifier (836) and the assignment selector (837).

The area identifier (836) is an interface element of the data capture view (831). The area identifier (836) identifies an area (e.g., “OUTSIDE”) of the worksite that work for a punch item is to be performed.

The assignment selector (837) is an interface element of the data capture view (831). The assignment selector (837) includes the text “Select Assignee” to indicate that the punch item has not been assigned.

Turning to FIG. 8E, the trade interface (842) is an updated version of the trade interface (835) of FIG. 8D. The trade interface (842) is displayed after interaction with the assignment selector (837) of FIG. 8D.

The option view (843) is an interface element of the trade interface (842). The option view (843) presents options for assigning a punch item. The options include name identifiers (e.g., “Antonio Tones”, “Ernesto Hernandez”, etc.). In one embodiment, the option view (843) is displayed in response to selection of the “Crew” option from the type selector (832). In one embodiment, the option view (843) is displayed as an overlay on top of the assignment view (829) (of FIG. 8C).

Turning to FIG. 8F, the trade interface (850) is updated from the trade interface (842) of FIG. 8E. The updates include updating the text in the assignment selector (837) to include a name identifier (“Antonio Tones”) selected from the option view (843) (of FIG. 8E).

The cancel button (851) is an interface element of the trade interface (850). Selection of the cancel button (851) proceeds without saving assignment data captured with the assignment view (829).

The save button (852) is an interface element of the trade interface (850). Selection of the save button (852) saves assignment data captured with the assignment view (829).

Turning to FIG. 8G, the trade interface (860) is updated from the trade interface (850) of FIG. 8F. The trade interface (860) includes updates to interface elements.

The reason selector (861) is an interface element of the punch list view (801). The reason selector (861) is used to collect data that identifies a reason for the punch item. In one embodiment, selection of the reason selector (861) may display a list of options from which to select a reason identifier with text that describes why a punch item was created.

The assignment summary (862) is an interface element of the punch list view (801). The assignment summary (862) may be displayed responsive to selecting the save button (852) from FIG. 8F. The assignment summary (862) includes multiple interface elements.

The name identifier (863) is an interface element of the assignment summary (862). The name identifier (863) includes text (“Antonio Tones”) that identifies the crew or crew member assigned to the punch item.

The assignment item (864) is an interface element of the assignment summary (862). The assignment item (864) is under the name identifier (863) to indicate that the assignment item (864) corresponds to a punch item assigned to “Antonio Tones”.

Turning to FIG. 8H, the trade interface (870) is updated from the trade interface (860) of FIG. 8G. The trade interface (870) includes updates to interface elements. The reason selector (861) is updated to display the text “Other” as a reason for the punch item.

The cancel button (871) is an interface element of the trade interface (870). The cancel button (871) may be selected to proceed without saving data for the assignments for punch items.

The submit walk button (872) is an interface element of the trade interface (870). The submit walk button (872) may be selected to proceed to save the data for the assignments for punch items.

FIG. 9A through FIG. 9E illustrate the use of a worker interface to capture information. FIG. 9A through FIG. 9E may illustrate an implementation of Step 428 of FIG. 4. Turning to FIG. 9A, the worker interface (900) is an updated version of the worker interface (575) of FIG. 5D. The worker interface (900) displays several interface elements, including the checklist view (534).

The checklist view (534) is updated to have the worksite item (505) displayed in the punch list (578) (instead of in the job list (504) as in FIG. 5D). The worksite item (505) is updated to include the days due identifier (901) and a change to the worksite item icon (902). In one embodiment, the days due identifier (901) includes the text “3d” colored green to indicate that the worksite item (505) is due to be completed in three days. The worksite item icon (902) is updated to be displayed with a blue background and a white stopwatch to indicate that work is to be performed for the worksite for the worksite item (505).

Turning to FIG. 9B, the worker interface (910) is an updated version of the worker interface (900) of FIG. 9A. The worker interface (910) displays the checklist view (534) with the punch item (911). The thumbnail (912) of the punch item (911) includes the counter (913) to indicate that 3 images are available to view for the punch item (911). In one embodiment, the item icon (914) of the punch item (911) includes a white background with a green checkmark to indicate that the punch item (911) has not been completed.

In one embodiment, interaction with the punch item (911) may bring up a camera application to capture an image of a worksite. For example, a slow press of the punch item (911) (e.g., the user of a mobile device touches the punch item (911) for an extended period of time, e.g., greater than 0.5 seconds) may reveal an icon to initiate an image capture process.

Turning to FIG. 9C, the worker interface (920) displays an image capture interface. The image (921) is a live image that includes the first watermark (922) and the second watermark (923). Selection of the cancel button (924) may close the image capture interface without saving the image (921). Selection of the capture button (925) may save the image (921) and may close the image capture interface.

Turning to FIG. 9D, the worker interface (930) includes updates to the interface elements of the punch item (911). The thumbnail (912) is updated to be based on the image (921) captured with the worker interface (920) of FIG. 9C. The counter (913) is updated with the text “4” to indicate that four images are available to show of the progress of work at the worksite for the punch item (911). In one embodiment, the item icon (914) is updated to include a green background and a white checkmark to indicate the punch item (911) is complete. Selection of the submit button (931) may submit the changes to the punch item (911) to the system.

Turning to FIG. 9E, the worker interface (940) includes updates to the worksite item (505). In one embodiment, the worksite item icon (902) of the worksite item (505) is updated to include a green background and a white checkmark to indicate that the worksite item (505) is complete. The status identifier (941) is updated with the text “Complete”.

FIG. 10A through FIG. 10D illustrate the use of a trade interface to capture information. FIG. 10A through FIG. 10D may illustrate an implementation of Step 430 of FIG. 4. Turning to FIG. 10A, the trade interface (1000) is an updated version of the trade interface (625) of FIG. 6B. The trade interface (1000) is displayed after the user opens the trade application at the worksite. The checklist items of the checklist view (627) are disabled (and shown with a lower contrast or higher brightness) until the start button (1001) is selected.

In one embodiment, the start button (1001) may be enabled when a location of the client device is determined to be within a geofence of the worksite. For example, the client device may include a positioning module that provides geophysical location coordinates. The geophysical location coordinates are compared to a geofence that surrounds the worksite, e.g., the location of “111722 Allen Road, Carrollton”.

Turning to FIG. 10B, the trade interface (1010) is an updated version of the trade interface (1000) of FIG. 10A. The checklist view (627) is updated by scrolling up or down to view additional checklist items, including the checklist item (1011). The checklist item (1011) includes the thumbnail (1012) and the counter (1013), which indicates that 4 images are available for the checklist item (1011). In one embodiment, the item icon (1014) includes a white background color and green checkmark to indicate the checklist item (1011) has not been started.

Turning to FIG. 10C, the trade interface (1020) is an updated version of the trade interface (1010) of FIG. 10B. The trade interface (1020) may be displayed after selecting to capture an image with the checklist item (1011) (of FIG. 10B). The trade interface (1020) may include a capture view that shows a live video image with icons for capturing an image (e.g., the image (1021)) from the live video image. The image (1021) may be captured as a review image to provide evidence that work for a punch item is complete. The capture button (1022) may be selected to capture the image (1021). In one embodiment, additional highlights may be drawn onto the Turning to FIG. 10D, the trade interface (1030) is an updated version of the trade interface (1010) of FIG. 10B. The trade interface (1030) includes updates to the checklist item (1011). The thumbnail (1012) is updated to be based on the image (1021) captured using the trade interface (1020). The counter (1013) is updated to “5” to indicate the availability of 5 images that document the progress of work for the checklist item (1011). In one embodiment, the item icon (1014) is updated to include a green background and a white checkmark to indicate that the checklist item (1011) is completed.

FIG. 11A through FIG. 11D illustrate the use of a builder interface to capture information. FIG. 11A through FIG. 11D may illustrate an implementation of Step 432 of FIG. 4. Turning to FIG. 11A, the builder interface (1100) is an updated version of the builder interface (760) of FIG. 7G. The builder interface (1100) is displayed after updates are made to the system using trade and worker interfaces. In one embodiment, the item icon (764) is updated to include a white background color and green checkmark to indicate the checklist item (703) is not complete.

The item notification icon (761) indicates the checklist item (703) is updated. The updates include the addition of a fourth image and a fifth image. The fourth image is the image (921) captured with the worker interface (920) of FIG. 9C. The fifth image is the image (1021) captured using the trade interface (1020) of FIG. 10C.

Turning to FIG. 11B, the builder interface (1110) is an updated version of the builder interface (1100) of FIG. 11A. The builder interface (1110) displays the image (1021), which was captured with the trade interface (1020) of FIG. 10C. Selecting the close button (1111) closes the display of images with the builder interface (1110).

In one embodiment, older images may be viewed by swiping left on the image (1021) and newer images may be viewed by swiping right. For example, swiping left on the image (1021) in the builder interface (1110) may display the image (921) of FIG. 9C. Swiping right after displaying the image (921) would then display the image (1021).

Turning to FIG. 11C, the builder interface (1120) is an updated version of the builder interface (1000) of FIG. 11A. The builder interface (1120) is displayed after selecting the close button (1111) of FIG. 11B. The checklist item (703) is displayed with the item icon (764) indicating that the checklist item (703) is not completed. The checklist item (703) is also displayed without the item notification icon (761) of FIG. 7G, having been removed in response to displaying the image (1021) (in FIG. 11B).

Turning to FIG. 11D, the builder interface (1130) is an updated version of the builder interface (1120) of FIG. 11C. The builder interface (1130) is updated after selection of the item icon (764). In one embodiment, the item icon (764) is updated to include a green background color and a white checkmark to indicate that the checklist item (703) is completed.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 12A, the computing system (1200) may include one or more computer processors (1202), non-persistent storage (1204), persistent storage (1206), a communication interface (1212) (e.g., Bluetooth interface, infrared interface, network interface, optical interface, etc.), and numerous other elements and functionalities that implement the features and elements of the disclosure. The computer processor(s) (1202) may be an integrated circuit for processing instructions. The computer processor(s) may be one or more cores or micro-cores of a processor. The computer processor(s) (1202) includes one or more processors. The one or more processors may include a central processing unit (CPU), a graphics processing unit (GPU), a tensor processing unit (TPU), combinations thereof, etc.

The input device(s) (1210) may include a touchscreen, keyboard, mouse, microphone, touchpad, electronic pen, or any other type of input device. The input device(s) (1210) may receive inputs from a user that are responsive to data and messages presented by the output device(s) (1208). The inputs may include text input, audio input, video input, etc., which may be processed and transmitted by the computing system (1200) in accordance with the disclosure. The communication interface (1212) may include an integrated circuit for connecting the computing system (1200) to a network (not shown) (e.g., a local area network (LAN), a wide area network (WAN) such as the Internet, mobile network, or any other type of network) and/or to another device, such as another computing device.

Further, the output device(s) (1208) may include a display device, a printer, external storage, or any other output device. One or more of the output devices may be the same or different from the input device(s). The input and output device(s) may be locally or remotely connected to the computer processor(s) (1202). Many different types of computing systems exist, and the aforementioned input and output device(s) may take other forms. The output device(s) (1208) may display data and messages that are transmitted and received by the computing system (1200). The data and messages may include text, audio, video, etc., and include the data and messages described above in the other figures of the disclosure.

Software instructions in the form of computer readable program code to perform embodiments may be stored, in whole or in part, temporarily or permanently, on a computer program product that includes a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1200) in FIG. 12A may be connected to or be a part of a network. For example, as shown in FIG. 12B, the network (1220) may include multiple nodes (e.g., node X (1222), node Y (1224)). Each node may correspond to a computing system, such as the computing system shown in FIG. 12A, or a group of nodes combined may correspond to the computing system shown in FIG. 12A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1200) may be located at a remote location and connected to the other elements over a network.

The nodes (e.g., node X (1222), node Y (1224)) in the network (1220) may be configured to provide services for a client device (1226), including receiving requests and transmitting responses to the client device (1226). For example, the nodes may be part of a cloud computing system. The client device (1226) may be a computing system, such as the computing system shown in FIG. 12A. Further, the client device (1226) may include and/or perform all or a portion of one or more embodiments of the invention.

The computing system of FIG. 12A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A method comprising:
receiving a punch image from a builder interface, wherein the punch image depicts a worksite corresponding to a task of a checklist item presented in a checklist view;
updating the checklist item with a punch thumbnail corresponding to the punch image;
presenting the checklist view with a notification and with the checklist item updated to comprise a punch review thumbnail of a punch review image from a trade interface;
presenting the punch review image from the trade interface responsive to the punch review thumbnail; and
updating the checklist item with a punch review thumbnail corresponding to the punch review image.

2. The method of claim 1, further comprising:
presenting a punch task image from a worker interface responsive to the punch review image;
presenting a punch image from the builder interface responsive to the punch task image;
presenting a review image from the trade interface responsive to the punch image; and
presenting the task image from the worker interface responsive to the review image.

3. The method of claim 1, further comprising:
presenting the checklist view with a header comprising a plurality of identifiers, wherein the plurality of identifiers comprise a property identifier, a date identifier, an application identifier, a community identifier, and a task identifier.

4. The method of claim 1, further comprising:
presenting the checklist view with the checklist item replaced with a set of icons, wherein the set of icons includes a photo icon, a punch icon, and a null icon.

5. The method of claim 1, further comprising:
presenting the checklist view with a photo icon; and
receiving the punch image responsive to selection of the photo icon.

6. The method of claim 1, further comprising:
presenting the checklist view with a punch icon; and
presenting a punch menu responsive to selection of the punch icon.

7. The method of claim 1, further comprising:
presenting a punch menu responsive to selection of a punch icon; and
receiving a punch description using the punch menu.

8. The method of claim 1, further comprising:
presenting a punch menu responsive to selection of a punch icon; and
receiving a trade selection using the punch menu.

9. The method of claim 1, further comprising:
updating an icon of the checklist item responsive to selection of a punch icon.

10. The method of claim 1, further comprising:
updating an icon of the checklist item responsive to the notification.

11. A system comprising:
at least one processor;
an image controller configured to generate a punch thumbnail from a punch image;
an application executing on the at least one processor and configured for:
receiving the punch image from a builder interface, wherein the punch image depicts a worksite corresponding to a task of a checklist item presented in a checklist view;
updating the checklist item with the punch thumbnail corresponding to the punch image;
presenting the checklist view with a notification and with the checklist item updated to comprise a punch review thumbnail of a punch review image from a trade interface;
presenting the punch review image from the trade interface responsive to the punch review thumbnail; and
updating the checklist item with a punch review thumbnail corresponding to the punch review image.

12. The system of claim 11, wherein the application is further configured for: presenting a punch task image from a worker interface responsive to the punch review image;
presenting a punch image from the builder interface responsive to the punch task image;
presenting a review image from the trade interface responsive to the punch image; and
presenting the task image from the worker interface responsive to the review image.

13. The system of claim 11, wherein the application is further configured for: presenting the checklist view with a header comprising a plurality of identifiers, wherein the plurality of identifiers comprise a property identifier, a date identifier, an application identifier, a community identifier, and a task identifier.

14. The system of claim 11, wherein the application is further configured for: presenting the checklist view with the checklist item replaced with a set of icons, wherein the set of icons includes a photo icon, a punch icon, and a null icon.

15. The system of claim 11, wherein the application is further configured for: presenting the checklist view with a photo icon; and
receiving the punch image responsive to selection of the photo icon.

16. The system of claim 11, wherein the application is further configured for: presenting the checklist view with a punch icon; and
presenting a punch menu responsive to selection of the punch icon.

17. The system of claim 11, wherein the application is further configured for: presenting a punch menu responsive to selection of a punch icon; and
receiving a punch description using the punch menu.

18. The system of claim 11, wherein the application is further configured for: presenting a punch menu responsive to selection of a punch icon; and
receiving a trade selection using the punch menu.

19. The system of claim 11, wherein the application is further configured for: updating an icon of the checklist item responsive to selection of a punch icon.

20. A computer program product comprising non-transitory computer-readable program code that, when executed by a computer processor of a computing system, causes the computing system to perform operations comprising:
receiving a punch image from a builder interface, wherein the punch image depicts a worksite corresponding to a task of a checklist item presented in a checklist view;
updating the checklist item with a punch thumbnail corresponding to the punch image;
presenting the checklist view with a notification and with the checklist item updated to comprise a punch review thumbnail of a punch review image from a trade interface;
presenting the punch review image from the trade interface responsive to the punch review thumbnail; and
updating the checklist item with a punch review thumbnail corresponding to the punch review image.
